(19) United States
(12) Patent Application Publication
(10) Pub. No.: US 2026/0046514 A1
(43) Pub. Date: Feb. 12, 2026

(54) DETECTING OBJECTS IN IMAGES

(71) Applicant: QUALCOMM Incorporated, San Diego, CA (US)

(72) Inventors: Wei-Te CHANG, Taipei City (TW); Yi-Han LIAO, Neihu District (TW); Wen-Chun FENG, New Taipei City (TW); Wei-Chih LIU, Taipei City (TW)

(21) Appl. No.: 18/796,030

(22) Filed: Aug. 6, 2024

(51) Int. Cl. H04N 23/667; H04N 23/61; H04N 23/62; H04N 23/73

(52) U.S. Cl. CPC H04N 23/667; H04N 23/61; H04N 23/62; H04N 23/73

(57) ABSTRACT

Systems and techniques are described herein for processing one or more image frames. For instance, a method for processing one or more image frames is provided. The method may include receiving a first series of image frames from an image sensor; providing the first series of image frames to a display to be displayed; initiating an object-detection mode based on the first series of image frames; responsive to initiating the object-detection mode, initiating capture of a second series of image frames; determining exposures for the second series of image frames based on the second series of image frames; and storing an image frame of the second series of image frames.

### TECHNICAL FIELD

The present disclosure generally relates to imaging. For example, aspects of the present disclosure include systems and techniques for detecting objects in images, such as images with a high degree of contrast.

### BACKGROUND

A camera is a device that receives light and captures image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size (also referred to as f/stop), focus, gain (including analog and/or digital gain), among others. Moreover, image-processing settings can be configured for post-processing of an image, such as alterations to contrast, brightness, saturation, sharpness, levels, curves, and colors, among others.

In photography, the term “exposure” or “exposure duration,” relating to an image captured by a camera, refers to the amount of light per unit area that reaches a photographic film, or in modern cameras, an electronic image sensor (e.g., including an array of photodiodes) when capturing the image. The exposure is based on certain image-capture settings such as, for example, exposure time and/or lens aperture, as well as the luminance of the scene being photographed. Because of the relationship between the amount of light that reaches an image sensor and the duration of time the image sensor is allowed to capture the light, the term “exposure” may refer to a duration of time during which the electronic image sensor is exposed to light (e.g., while the electronic image sensor is capturing an image).

Many cameras are equipped with an automatic exposure or “auto exposure” mode that may adjust the image-capture settings (e.g., exposure time, lens aperture, etc.) of the camera based on the luminance of a scene or subject being photographed. In some cases, an automatic exposure control (AEC) engine can perform AEC to determine image-capture settings for an image sensor. For example, when a camera is used to capture images of a dark scene, the AEC engine may adjust the image-capture settings to increase the brightness of images captured by the camera such that details are not lost in underexposed pixels. In some examples, the AEC engine may increase the ISO, the exposure time, the aperture size, and/or the gain to increase the brightness. Similarly, when a camera is used to capture images of a bright scene, the AEC engine may adjust the image-capture settings to decrease the brightness of the images capture by the camera such that details are not lost in overexposed pixels. In some examples, the AEC engine may decrease the ISO, the exposure time, the aperture size, and/or the gain to decrease the brightness.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing one or more image frames. According to at least one example, a method is provided for processing one or more image frames. The method includes: receiving a first series of image frames from an image sensor; providing the first series of image frames to a display to be displayed; initiating an object-detection mode based on the first series of image frames; responsive to initiating the object-detection mode, initiating capture of a second series of image frames; determining exposures for the second series of image frames based on the second series of image frames; and storing an image frame of the second series of image frames.

In another example, an apparatus for processing one or more image frames is provided that includes at least one memory and at least one processor (e.g., configured in circuitry) coupled to the at least one memory. The at least one processor configured to: receive a first series of image frames from an image sensor; provide the first series of image frames to a display to be displayed; initiate an object-detection mode based on the first series of image frames; responsive to initiating the object-detection mode, initiate capture of a second series of image frames; determine exposures for the second series of image frames based on the second series of image frames; and store an image frame of the second series of image frames.

In another example, a non-transitory computer-readable medium is provided that has stored thereon instructions that, when executed by one or more processors, cause the one or more processors to: receive a first series of image frames from an image sensor; provide the first series of image frames to a display to be displayed; initiate an object-detection mode based on the first series of image frames; responsive to initiating the object-detection mode, initiate capture of a second series of image frames; determine exposures for the second series of image frames based on the second series of image frames; and store an image frame of the second series of image frames.

In another example, an apparatus for processing one or more image frames is provided. The apparatus includes: means for receiving a first series of image frames from an image sensor; means for providing the first series of image frames to a display to be displayed; means for initiating an object-detection mode based on the first series of image frames; means for responsive to initiating the object-detection mode, initiating capture of a second series of image frames; means for determining exposures for the second series of image frames based on the second series of image frames; and means for storing an image frame of the second series of image frames.

In some aspects, one or more of the apparatuses described herein is, can be part of, or can include an extended reality device (e.g., a virtual reality (VR) device, an application specific integrated circuits (ASICs) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, according to various aspects of the present disclosure;

FIG. 2 includes 15 images to illustrate example operations of automatic exposure control (AEC);

FIG. 3 includes two example images with different exposures used to create a composite image;

FIG. 4 includes a number of images of the moon captured using various image-capture settings;

FIG. 5 includes two images of the moon, one of which is enhanced;

FIG. 6 includes four images of the moon in a scene captured at four respective zoom ratios;

FIG. 7 includes four images of the moon that may be captured with various image-capture settings in the process of detecting the moon in the images;

FIG. 8 includes six images that may be captured in the process of determining whether any of the six images include the moon;

FIG. 9 includes four example images, two captured according to first image-capture settings and two captured according to second image-capture settings, according to various aspects of the present disclosure;

FIG. 10 includes six example images, four captured according to first image-capture settings and two captured according to second image-capture settings, according to various aspects of the present disclosure;

FIG. 11 includes seven example preview images, according to various aspects of the present disclosure;

FIG. 12 includes seven example preview images, according to various aspects of the present disclosure;

FIG. 13 includes seven example preview images, according to various aspects of the present disclosure;

FIG. 14 includes seven example images of a first stream of image data, according to various aspects of the present disclosure;

FIG. 15 includes five example images of a second stream of image data, according to various aspects of the present disclosure;

FIG. 16A is a block diagram of an example system for imaging, according to various aspects of the present disclosure;

FIG. 16B includes two example images with different exposures used to create a composite image;

FIG. 17 is a block diagram illustrating the example processor of FIG. 16A including elements representative of processes, modules, routines, algorithms, etc. implemented by the processor, according to various aspects of the present disclosure;

FIG. 18 includes a flow diagram illustrating a process for imaging, according to various aspects of the present disclosure;

FIG. 19 is a flow diagram illustrating an example process for imaging, in accordance with aspects of the present disclosure;

FIG. 20 is a block diagram illustrating an example of a deep learning neural network that can be used to perform various tasks, according to some aspects of the disclosed technology;

FIG. 21 is a block diagram illustrating an example of a convolutional neural network (CNN), according to various aspects of the present disclosure; and

FIG. 22 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision (CV), extended reality (e.g., augmented reality (AR), virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

In photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

Many cameras are equipped with an automatic exposure or “auto exposure” mode, where the image-capture settings (e.g., exposure time, lens aperture, etc.) of the camera may be automatically adjusted to match, as closely as possible, the luminance of a scene or subject being photographed. In some cases, an automatic exposure control (AEC) engine can perform AEC to determine image-capture settings for an image sensor. An AEC engine may seek to limit a number of pixels in an image frame that are overexposed and a number of pixels in an image frame that are underexposed. For example, an AEC engine may examine a first image, and determine image-capture settings for a subsequent image based on the exposure of the first image. For example, when a camera is capturing video data, the AEC engine may examine each frame and determine image-capture settings for each frame based on the exposure of the preceding frames. As another example, a camera may capture test frames (which may be displayed, for example, as preview frames to a user as they are composing a shot), and the AEC engine may determine image-capture settings based on the exposure of test frames.

As described above, an automatic exposure control (AEC) engine may adjust image-capture settings (e.g., exposure time, lens aperture, etc.) of a camera based on the luminance of a scene or subject being photographed so that images captured by the camera are properly exposed (e.g., not overexposed and not underexposed). An AEC engine may iteratively adjust the image-capture settings based on captured images until the images captured are at a target average brightness. For example, a camera may capture a first image. An AEC engine of the camera may determine that the first image is overexposed and adjust image-capture settings. The camera may capture a second image using the adjusted image-capture settings. The AEC may determine whether the second image is overexposed or not. If the images is overexposed, the AEC engine may adjust the image-capture settings again and the camera may capture a third image using the further adjusted image-capture settings. The AEC engine may iteratively adjust the image-capture settings until captured images are not overexposed. Thus, it may take time (e.g., while the multiple images are captured and/or processed) for the AEC engine to adjust to the darkness or brightness of a scene.

Additionally, in photography and videography, a technique called high dynamic range (HDR) allows the dynamic range of image frames captured by a camera to be increased beyond the native capability of the camera. In this context, the term “dynamic range” refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames into a single image frame. The combination of image frames with different exposures can result in an image with a dynamic range higher than that of each individual image frame captured and combined to form the HDR image frame. For example, the electronic device can create a high dynamic image frame by combining two or more image frames with different exposures into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In the present disclosure, the term “combine,” and like terms, with reference to images or image data, may refer to any suitable techniques for using information (e.g., pixels) from two or more images to generate an image (e.g., a “composite” image). For example, pixels from a first image and pixels from a second image may be combined to generate a composite image. In such cases some of the pixels of the composite image may be from the first image and others of the pixels of the composite image may be from the second image. In some cases, some of the pixels from the first image and the second image may be merged, fused, or blended. For example, color and/or intensity values for pixels of the composite image may be based on respective pixels from both the first image and the second image. For instance, a given pixel of the composite image may be based on an average, or a weighted average, between a corresponding pixel of the first image and a corresponding pixel of the second image (e.g., the corresponding pixels of the first image and the second image may be blended). As one example, a central region of a first image may be included in a composite image. Further, an outer region of a second of a second image may be included in the composite image. Pixels surrounding the central region in the composite image may be based on weighted averages between corresponding pixels of the first image and corresponding pixels of the second image. In other words, pixels of the first image surrounding the central region may be merged, fused, or blended with pixels of the second image inside the outer region.

In some cases, an imaging device can generate an HDR image by combining multiple images that captured with different image-capture settings. For instance, an imaging device can generate an HDR image by combining a shorter-exposure image captured with a shorter exposure time and a longer-exposure image captured with a longer exposure time that is longer than the shorter exposure time. As another example, the imaging device can create an HDR image using a shorter-exposure image, a medium exposure image (that is capture with a medium exposure time that is between the shorter exposure time and the longer exposure time), and a longer-exposure image.

Because shorter-exposure images are generally darker, they preserve the most detail in the highlights (brighter areas) of a photographed scene. Medium-exposure images and the longer-exposure images are generally brighter than shorter-exposure images, and may be overexposed (e.g., too bright to make out details) in the highlight portions (brighter areas) of the scene. Because longer-exposure images generally include brighter portions, they may preserve detail in the shadows (darker areas) of a photographed scene. Medium-exposure images and the shorter-exposure images are generally darker than longer-exposure images, and may be underexposed (e.g., too dark to make out details in) in the shadow portions (darker areas) of the scene, making their depictions of the shadows too dark to observe details. To generate an HDR image, the imaging device may, for example, use portions of the shorter-exposure image to depict highlights (brighter areas) of the photographed scene, use portions of the longer-exposure image depicting shadows (darker areas) of the scene, and use portions of the medium-exposure image depicting other areas (other than highlights and shadows) of a scene.

Capturing satisfying images of high-contrast objects may be difficult. For example, it may be difficult to capture a satisfying image of the moon because an AEC algorithm may determine relatively a high exposure value (EV) for image-capture settings based on a majority of a scene including the moon being relatively dark. The relatively high EV may cause the moon to be overexposed. The moon may be a “high-contrast” object because the moon may be brighter than a scene surrounding the moon (e.g., the night sky). In the present disclosure, the term “high-contrast object” may refer to a difference between a brightness of the object relative to a scene surrounding the object. In an image of a scene including a bright high-contrast object, the high-contrast object may be overexposed when the scene is properly exposed, or the high-contrast object may properly exposed when the scene is underexposed. In an image of a scene including a dark high-contrast object, the high-contrast object may be underexposed when the scene is properly exposed, or the high-contrast object may properly exposed when the scene is overexposed. It may not be possible to capture a single image of a scene and a high-contrast object in which the scene and the high-contrast object are both properly exposed.

Systems, apparatuses, methods (also referred to as processes), and computer-readable media (collectively referred to herein as “systems and techniques”) are described herein for capturing images of high-contrast objects. For example, the systems and techniques described herein may capture two streams of image data at the same time. The systems and techniques may adjust image-capture settings for capturing first stream of image data separately from the image-capture settings of the second stream of image data. The systems and techniques may implement object-detection techniques on one or both of the streams of image data.

For example, the systems and techniques may capture a first stream of image data. The systems and techniques may adjust the image-capture settings of the first stream of image data to be appropriate for the scene represented in the first stream of image data (e.g., according to AEC). The systems and techniques may display the first stream of image data (e.g., as preview images) at a display. The systems and techniques may determine a probability that a candidate object in the first stream of image data is a particular object (e.g., a high-contrast object, such as the moon). The candidate object may be overexposed in the first stream of image data, based on the image-capture settings of the first stream of image data being set according to AEC for the scene. It may not be possible to determine, with certainty, whether the candidate object is the particular object because the candidate object is overexposed in the first stream of image data.

Based on the probability exceeding a probability threshold, the systems and techniques may initiate an object-detection mode and initiate capturing a second stream of image data. The systems and techniques may initiate the second stream of image data with image-capture settings that are offset from the image-capture settings of the first stream of image data. The systems and techniques may adjust the image-capture settings of the second stream of image data separately from the image-capture settings of the first stream of image data. Further, the systems and techniques may adjust the image-capture settings of the second stream of image data to properly expose the candidate object (e.g., rather than the scene). The systems and techniques may perform an object-detection technique using the second stream of image data to determine whether the candidate object in the second stream of image data is the particular object. Because the image-capture settings of the second stream of image data are adjusted based on the candidate object, it may be possible to determine, with greater confidence, whether the candidate object is the particular object or not. If the systems and techniques determine that the candidate object is the particular object, the systems and techniques may perform one or more operations, such as storing one or more images of the second stream of image data, outputting an indication (e.g., a moon flag), or generating one or more composite images using images of the first stream of image data and images of the second stream of image data.

While capturing the second stream of image data and adjusting the image-capture settings of the second stream of image data the systems and techniques may continue to capture the first stream of image data and adjust the image-capture settings of the first stream of image data independent of the image-capture settings of the second stream of image data. Further the systems and techniques may perform task using the first stream of image data. For example, the systems and techniques may continue to display the first stream of image data at the display and/or to store the first stream of image data in memory.

Various aspects of the application will be described with respect to the figures below.

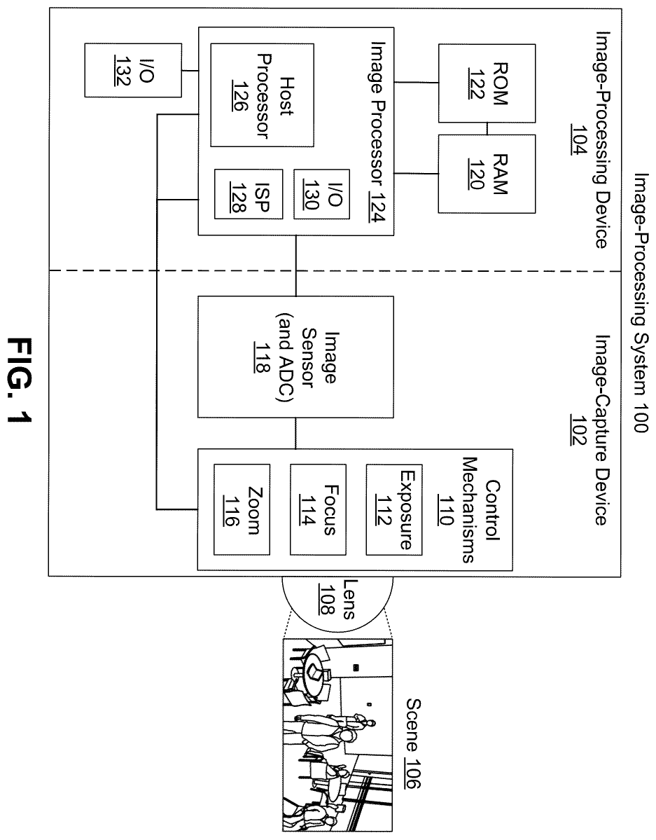

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an infrared (IR) cut filter, an ultraviolet (UV) cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

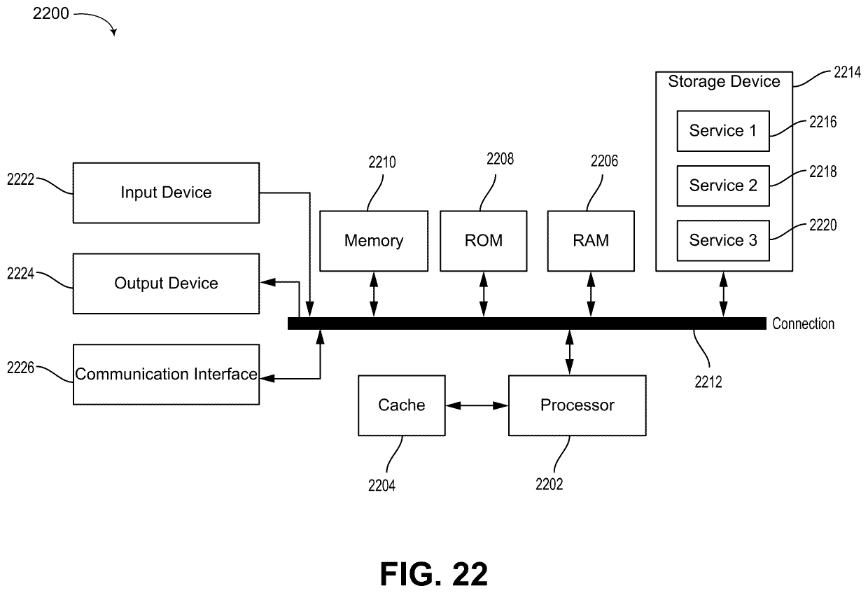

The image processor 124 may include one or more processors, such as one or more image signal processors (ISPs) (including ISP 128), one or more host processors (including host processor 126), and/or one or more of any other type of processor discussed with respect to the computing-device architecture 2200 of FIG. 22. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., third generation (3G), fourth generation (4G) or long-term evolution (LTE), fifth generation (5G), etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure control (AEC), automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

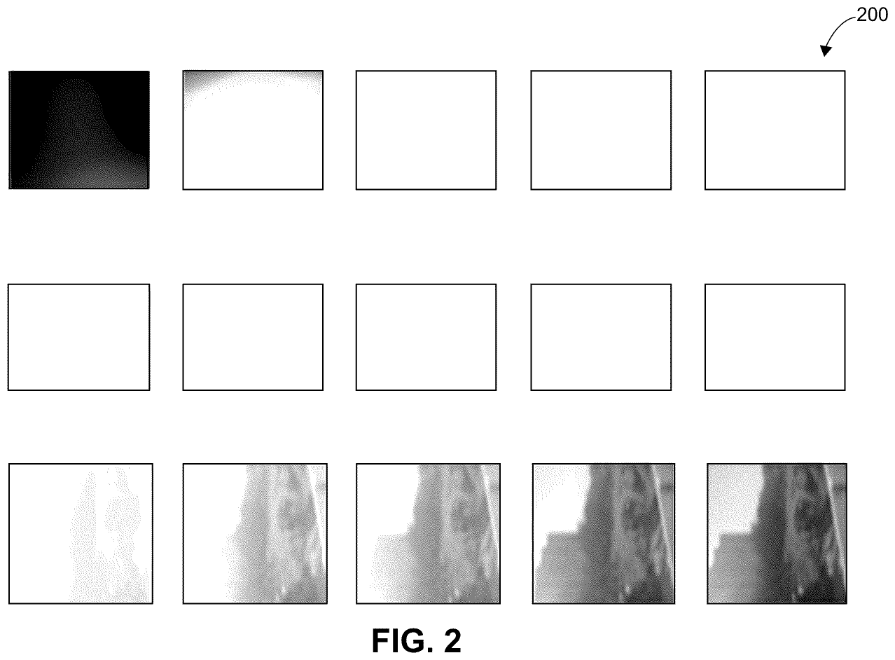

As mentioned above, because an AEC engine (e.g., implemented by image processor 124) iteratively adjusts exposure (e.g., using exposure-control mechanism 112) as multiple images are captured, it may take time (e.g., while the multiple images are captured and/or processed) for the AEC engine to adjust to the darkness or brightness of a scene. For example, if a camera is moved from a relatively dark area to bright area (e.g., from inside a dark room to outside in the daylight) while repeatedly capturing frames (e.g., capturing video data), the camera may capture several frames that are overexposed (e.g., while the AEC engine adjusts the image-capture settings to match the bright scene). For example, FIG. 2 includes 15 images 200 to illustrate example operations of AEC. The first image may be captured in a dark area. The next 14 images may be captured in a bright area. The AEC engine may iteratively adjust the image-capture settings used to capture the 14 images to cause the brightness of the images to match the scene.

Returning to FIG. 1, various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an internet protocol (IP) camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an head-mounted device (HMD), smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 2200 shown in FIG. 22 and further described below can include the image-processing system 100, the image-capture device 102, the image-processing device 104, or a combination thereof.

In some examples, the image-processing system 100 can create an HDR image using multiple image frames with different exposures. For example, the image-processing system 100 can create an HDR image using a shorter exposure (SE) image, a medium exposure (ME) image, and a longer exposure (LE) image. As another example, the image-processing system 100 can create an HDR image using an SE image and an LE image. In some cases, the image-processing system 100 can write the different image frames from one or more camera frontend engines to a memory device, such as a DDR memory device or any other memory device (e.g., RAM 120). A post-processing engine can then retrieve the image frames and fuse (e.g., merge, combine) them into a single image.

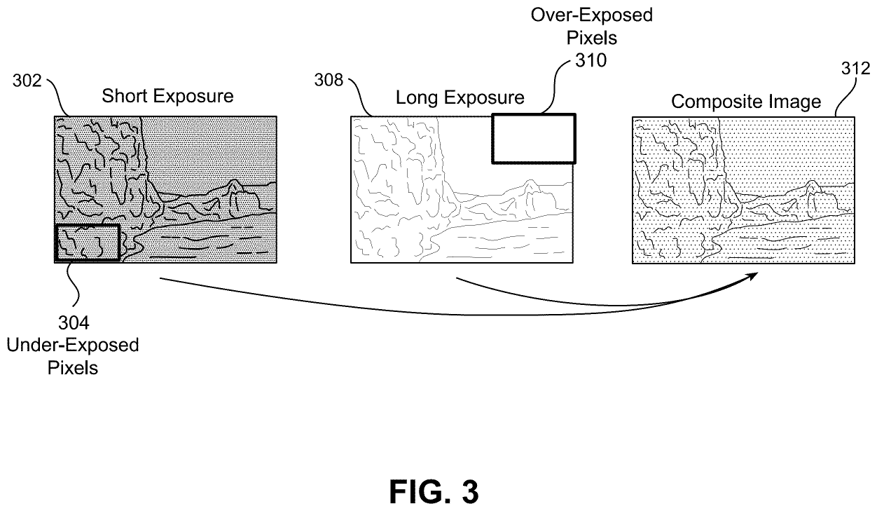

FIG. 3 includes two example images with different exposures used to create a composite image (e.g., composite image 312). For example, FIG. 3 shows a shorter-exposure image 302, a longer-exposure image 308, and composite image 312 generated by combining pixels from shorter-exposure image 302 and longer-exposure image 308. Shorter-exposure image 302 includes under-exposed pixels 304, and longer-exposure image 308 includes over-exposed pixels 310. As shown in FIG. 3, under-exposed pixels 304 of shorter-exposure image 302 and over-exposed pixels 310 of the longer-exposure image 308 do not contribute to the pixels of the composite image 312. Other pixels of shorter-exposure image 302 may be blended with corresponding pixels of longer-exposure image 308 to generate corresponding pixels of composite image 312.

In general, an AEC engine may adjust image-capture settings such that an exposure of an image is appropriate for a majority of pixels of images or based on an average illumination of a scene being photographed. Adjusting exposure based on a majority of pixels of an image or based on an average illumination of a scene may have disappointing and/or undesirable results when a photographer desires to capture a scene including high contrast between a bright portion of a scene and dark portions of a scene.

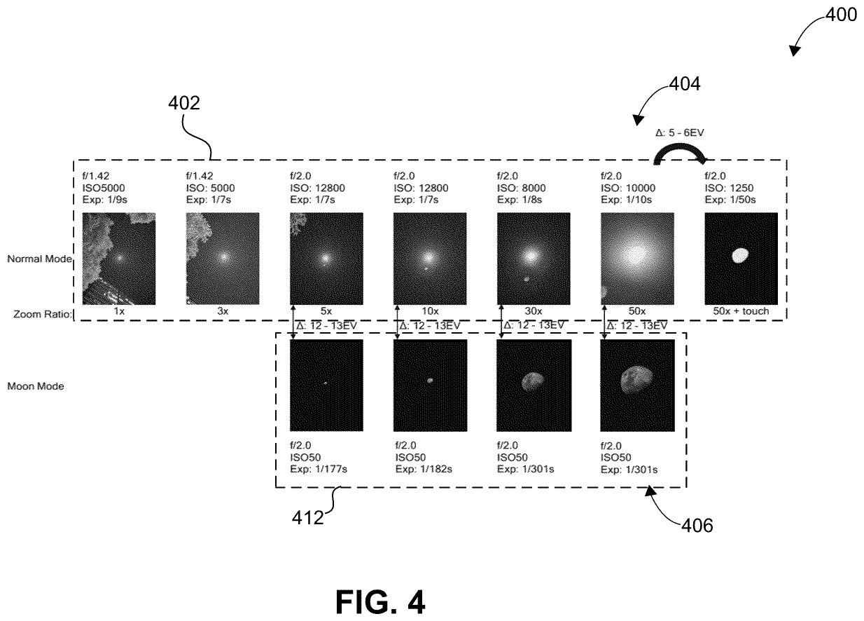

As an example, a photographer may desire to capture a photograph of the moon. FIG. 4 includes a number of images 400 of the moon captured using various image-capture settings. The moon may be bright compared to the dark night sky surrounding the moon. If an AEC engine determines an exposure value (EV) based on a majority of pixels in an image of the moon, the EV may be high which may result in the moon being overexposed and washed out. In the present disclosure, the term “exposure value” (“EV”) and like terms may refer to a combination of image-capture settings. For example, an EV may be based on an f/stop, an ISO, and/or an exposure duration. For instance, EV may be log 2 (N²/t) where N is the f/stop and t is the exposure time. FIG. 4 includes images 402 that may be captured according to an AEC algorithm. As an example, image 404 of FIG. 4 may be captured with an f/stop of 2.0, an ISO of 10,000, and an exposure duration of 1/10 second. In image 404, the moon is overexposed.

FIG. 4 also includes images 412, for which the image-capture settings may be selected to properly expose the moon. For example, image 414 may be captured using an EV of 12-13 less than the EV of image 404 (denoted A 12-13 EV). The EV of image 414 may be based on an f/stop of 2.0, an ISO of 50, and an exposure duration of 1/301 of a second. In image 414 the moon is not overexposed such that features of the moon are visible.

An AEC engine may not arrive at the EV or image 414 without special instructions. For example, an AEC engine may adjust image-capture settings based on an average brightness of images 400 and may arrive at an EV of image 404 based on the majority of pixels of each of images 400 being dark. Image 414 may be captured by a camera in a “moon mode.” Moon mode may set image-capture settings to have a low EV to capture details of bright objects in dark scenes (such as the moon).

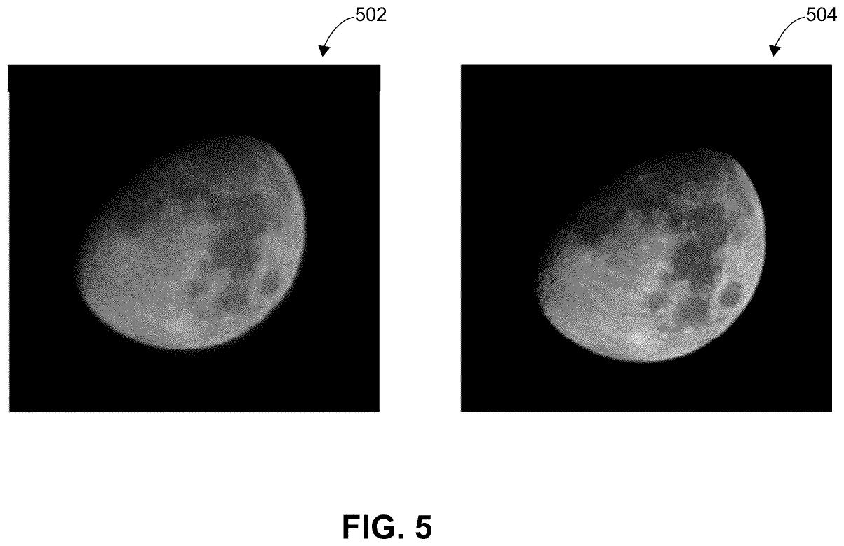

Some image-capture devices (e.g., cameras or computing devices including cameras) may enhance images of high-contrast objects (e.g., the moon). For example, FIG. 5 includes an image 502 of the moon and an image 504 of the moon. Image 502 and image 504 may each be captured at a zoom ratio of 70×. Image 504 may be enhanced. For example, image 504 may be processed with color processing and/or super resolution.

Super resolution may involve capturing a number of images of an object and using the number of images to generate a single image. Super resolution may result in clearer or sharper images based on a reduction of noise based on the use of multiple images.

Additionally or alternatively, some image-capture and/or image-processing devices may enhance photographs of the moon using machine-learning models trained to enhance photographs of the moon. For example, a machine-learning model may be trained to enhance the details of a photograph of the moon. For example, the machine-learning model may be trained using more detailed photographs of the moon as ground truth and less detailed photographs of the moon as inputs.

In some cases, a user may select a moon mode which may cause an AEC engine to set image-capture settings to capture images of the moon. For example, the images on the bottom half of FIG. 4 may be captured using a moon mode, which may have been user-selected. Further, the moon mode may further enable enhancements such as color processing and/or HDR. For example, image 504 of FIG. 5 may have been processed based on image 504 having been captured in moon mode. However, selecting moon mode may be inconvenient.

Various aspects of the present disclosure may include detecting the objects (e.g., the moon) in images (e.g., preview or test images). If the object is detected (or if the systems and techniques determine that there is a probability that the object is present in the images), aspects of the present disclosure may initiate an object-detection mode (e.g., a moon mode), adjust AEC settings, and/or enable enhancements automatically.

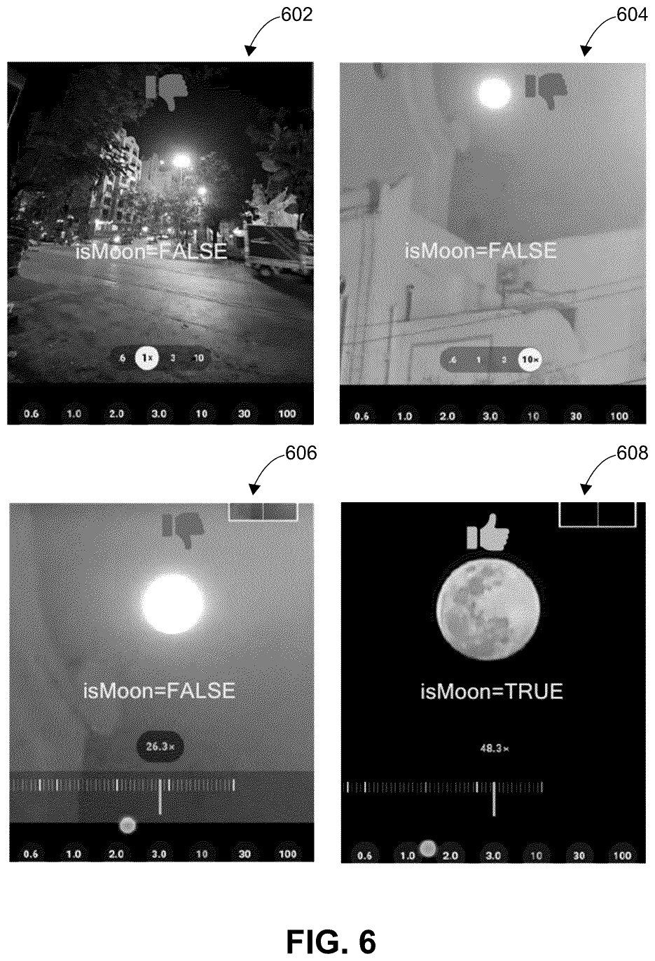

Detecting the moon in images may be difficult. For example, FIG. 6 includes four images (image 602, image 604, image 606, and image 608) of the moon in a scene captured at four respective zoom ratios.

Image 602 includes the moon and a surrounding scene captured at a zoom ratio of 1×. The moon is relatively small in image 602 and the scene is relatively bright compared to the moon. Thus, a moon detector may determine that image 602 does not include the moon. Thus the moon detector may set a moon flag false (e.g., isMoon=false). Such a determination would be incorrect, as indicated by the thumbs down icon overlaid onto image 602.

Similarly, the moon detector may fail to detect the moon in image 604 (e.g., based on the brightness of the scene relative to the moon) despite the 10× zoom ratio of image 604. The moon detector may also fail to detect the moon in image 606, despite the zoom ratio of 26.3. The moon detector may correctly identify the moon in image 608 based on most of the scene being excluded from image 608 because of the 48.3× zoom ratio.

Even at a high zoom ratio (excluding much of a background of a scene), it may be difficult to correctly detect the moon in images. For example, in order to detect the moon, various moon detectors may adjust an exposure of images to distinguish the moon from other light sources in a dark scene.

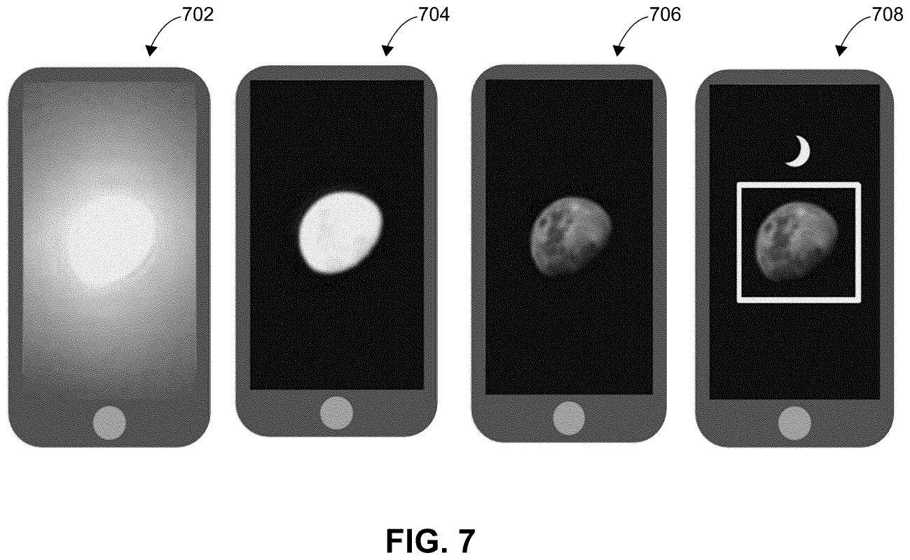

For example, FIG. 7 includes four images (image 702, image 704, image 706, and image 708) of the moon that may be captured with various image-capture settings in the process of detecting the moon in the images. For example, image 702 may be a first image of a scene. A moon detector may determine that an object in image 702 has a probability (e.g., beyond a threshold) of being the moon. The moon detector may change the image-capture settings of the camera and cause the camera to capture image 704 at a lower EV. The moon detector may determine that an object in image 704 has a probability (e.g., beyond a threshold) of being the moon. The moon detector may change the image-capture settings of the camera and cause the camera to capture image 706 at a lower EV. The moon detector may determine that the object in image 706 is properly exposed (e.g., that no further decrease in EV is necessary). The moon detector may detect the moon in image 706 (e.g., by determining, beyond a threshold probability, that the object is the moon. Additionally or alternatively, the moon detector may cause the camera to capture image 708 and detect the moon in image 708.

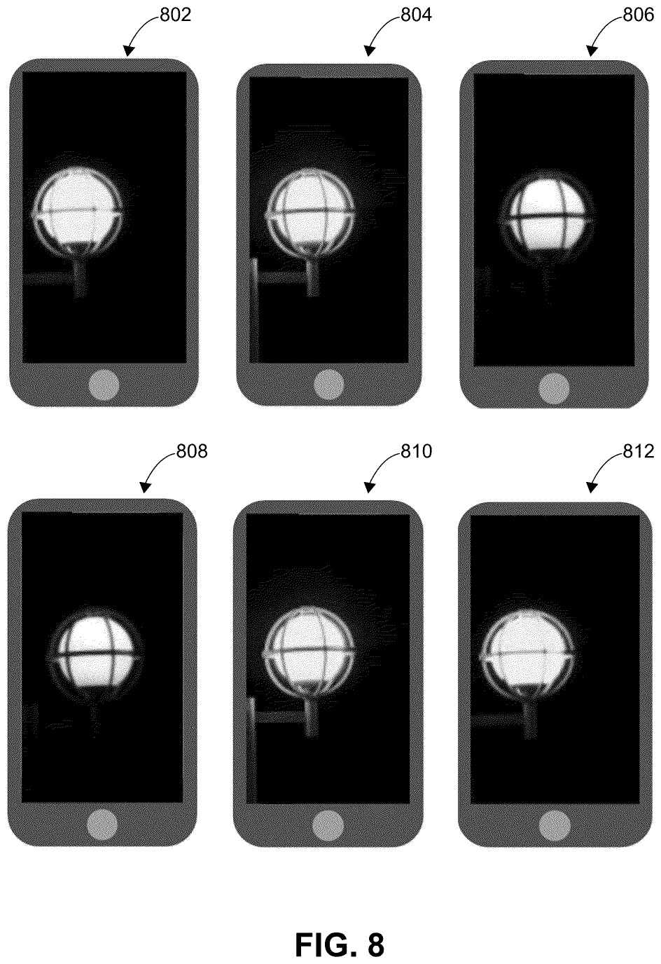

FIG. 8 includes six images (image 802, image 804, image 806, image 808, image 810, and image 812) that may be captured in the process of determining whether the images of FIG. 8 include the moon. For example, image 802 may be a first image of a scene. A moon detector may determine that an object in image 802 has a probability (e.g., beyond a threshold) of being the moon. The moon detector may change the image-capture settings of the camera and cause the camera to capture image 804 at a lower EV. The moon detector may determine that an object in image 804 has a probability (e.g., beyond a threshold) of being the moon. The moon detector may change the image-capture settings of the camera and cause the camera to capture image 806 at a lower EV. The moon detector may determine that the object in image 806 is properly exposed (e.g., that no further decrease in EV is necessary). The moon detector may determine that the object in image 806 is not the moon (e.g., by determining, beyond a threshold probability, that the object is not the moon) or, the moon detector may cause the camera to capture image 808 (e.g., using the same image-capture settings that were used to capture image 806) and determine that the object in image 808 is not the moon (e.g., by determining, beyond a threshold probability, that the object is not the moon).

In some cases, after determining that the object in image 808 is not the moon, the moon detector may return the image-capture settings to pre-moon-detection levels. For example, the moon detector may adjust the image-capture settings to restore the image-capture settings used to capture image 802. In some aspects, the moon detector may iteratively restore the pre-moon-detection image-capture settings (e.g., during the time it takes to capture image 810). Finally, with the image-capture settings restored to pre-moon-detection levels, the camera may capture image 812.

The images of FIG. 7 and FIG. 8 are presented as preview images on a display of a device (e.g., a smart phone). The images are presented as preview images because in many cases, images such as the images of FIG. 7 or the images of FIG. 8 will be captured and displayed on a display (e.g., as preview images) as the moon detector determines whether the images include the moon.

It may be frustrating to a user for a camera to display preview image frames with varying image-capture settings, such as if the user is trying to capture an image of another subject. For example, if a user is trying to capture an image of a friend, and there is an object in the background that is round and relatively bright, a moon detector may cause the camera to adjust image-capture settings to determine whether the object in the background is the moon or not. Meanwhile, the user may be looking at their friend in the display to frame the shot. The moon detector may decrease the EV of the images determine whether the object is the moon which may cause the friend, in the preview images, to be underexposed. Further, if the user presses a shutter button (e.g, to capture an image), the image may be with the adjusted EV settings and the friend may be underexposed.

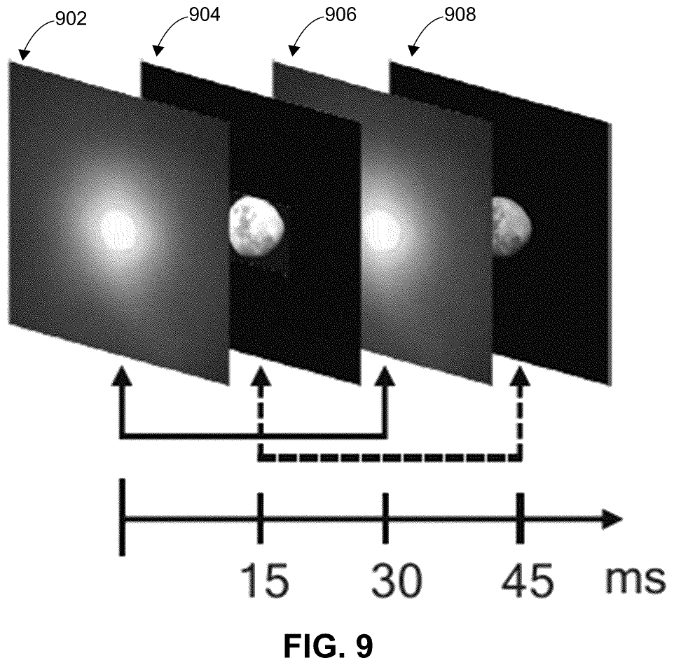

The systems and techniques may cause an image sensor (or multiple image sensors) to capture a first series of images using first image-capture settings and a second series of images using second image-capture settings. For example, FIG. 9 includes four example images, two captured according to first image-capture settings (e.g., image 902 and image 906) and two captured according to second image-capture settings (e.g., image 904 and image 908), according to various aspects of the present disclosure. The first image-capture settings may be according to an AEC for setting the exposure for the scene. The second image-capture settings may be according to an object-detection mode (e.g., a moon-detection mode). The object-detection mode may apply AEC to a portion of image 904 and image 908, such as the portion representing the object.

For example, an image-capture device (e.g., a camera or device including a camera) may capture the first series of images according to a default AEC. The systems and techniques may detect a moon-like object in an image of the first series of images. The systems and techniques may cause the image-capture device to begin capturing the second series of images according to a moon-detection mode. The systems and techniques may determine whether the moon is present in the images (e.g., the first series of images and the second series of images) based on the second series of images.

In other words, the systems and techniques may initiate a second stream of image data. For example, an image-capture device (e.g., a camera or device including a camera) may be operating a first stream of image data (e.g., capturing a first series of images). The image-capture device may be using the first stream of image data in any of a number of ways, including storing the first stream of image data (e.g., capturing and storing video data), transmitting the first stream of image data, processing the first stream of image data (e.g., making determinations based on the first stream of image data), and/or displaying the first stream of image data at a display (e.g., as preview images). The systems and techniques may determine a probability (e.g., beyond a threshold) that there may be a particular object (e.g., the moon) in images of the first stream of image data. Based on the determination, the systems and techniques may initiate a second stream of image data.

The systems and techniques may use the second stream of image data to determine whether the particular object is present in the images (e.g., with a higher degree of certainty). While determining whether the particular object is present, the systems and techniques may adjust image-capture settings of the second stream of image data separately from the first stream of image data. For example, the systems and techniques may determine image-capture settings for capturing the first stream of image data based on an AEC. Separately, the systems and techniques may determine image-capture settings for the second stream of image data based on a moon-detection mode (which may employ an AEC configured to focus on an object rather than the entire scene). For example, the systems and techniques may decrease the EV for capturing the second stream of image data (e.g., iteratively) to arrive at a proper exposure for the particular object.

In some aspects, after determining that the particular object is present in the images (e.g., beyond a threshold probability), the systems and techniques may store an image of the second stream of image data (e.g., a properly-exposed image of the particular object). Additionally or alternatively, the systems and techniques may enhance the image of the second stream of image data (e.g., as described with regard to FIG. 5). For example, the systems and techniques may capture a number of images from the second stream of image data and generate a super-resolution image using the number of images from the second stream of image data. Additionally or alternatively, the systems and techniques may generate a composite image based on the image from the second stream of image data and an image from the first stream of image data (e.g., as described with regard to FIG. 3).

In some aspects, the systems and techniques may store an image of the second stream of image data in response to a user input (e.g., a user pressing a shutter button or otherwise instructing the systems and techniques to capture an image). For example, after determining that the particular object (e.g., the moon) is present in the images, the systems and techniques may continue to capture the second stream of image data which may enable a user to capture an image of the particular object according to the second image-capture settings. In this way, the systems and techniques may enable a user to capture a properly-exposed image of the particular object.

Additionally, in response to the user input, the systems and techniques may store an image of the first stream of image data. Thus, the user may have access to a properly-exposed image of the particular object and access to a properly-exposed image of the scene. In some aspects, the systems and techniques may generate a composite image based on the image of the first stream of image data and the image of the second stream of image data.

In some aspects, the systems and techniques may continue detecting the moon in the second stream of image data. The systems and techniques may continue capturing images according to the second image-capture settings as long as the particular object is detected in images of the second stream of image data. If the particular object is not detected in a threshold number of sequential images of the second stream of image data, the systems and techniques may cease capturing images according to the second image-capture settings. In other words, the systems and techniques may cease the second stream of image data.

The systems and techniques may continue the first stream of image data and the use of the first stream of image data uninterrupted while capturing the second stream of images data and while determining whether the images include the particular object. For example, the image-capture device may continue to capture the first stream of images data and display the first stream of image data at the display (e.g., as preview images), transmit the first stream of image data, process, and/or to store the first stream of image data. The systems and techniques may adjust the image-capture settings for capturing the first stream of image data separate from the adjustments made to the second stream of image data.

In some aspects, the systems and techniques may initiate the second stream of image data using a second image sensor. For example, the image-capture device may be capturing the first stream of image data using a first image sensor. The systems and techniques may initiate capturing the second stream of image data using a second image sensor.

In other aspects, the systems and techniques may initiate the second stream of image data using the same image sensor that is capturing the first stream of image data. For example, the systems and techniques may cause the image sensor to capture the second stream of image data in a time-interleaved fashion with the first stream of image data. For instance, the systems and techniques may cause the image sensor to capture an image of the second stream of image data in between capturing images of the first stream of image data.

Referring to FIG. 9 as an example, the systems and techniques may cause an image sensor to capture image 902 (e.g., using first image-capture settings, for example, according to an AEC). Further, the systems and techniques may cause the image sensor to capture image 904 (e.g., using second image-capture settings, for example, according to an object-detection mode). Next, the systems and techniques may cause the image sensor to capture image 906 according to the first image-capture settings, then image 908 according to the second image-capture settings.

The image-capture device may capture image 902 and image 906 according to a pre-determined frame rate (e.g., 30 frames per second (fps)). The image-capture device may display image 902 and image 906 at a display, transmit image 902 and image 906, and/or store image 902 and image 906 at the pre-determined frame rate (or at another rate). At a rate of 30 fps, the image-capture device may display and/or store an image every 1/30 second. Between the time when image 902 and image 906 are captured, the systems and techniques may cause the image sensor to capture image 904. Similarly, after image 906 is captured, the systems and techniques may cause the image sensor to capture image 908, for example, before the image sensor captures another image using the first image-capture settings.

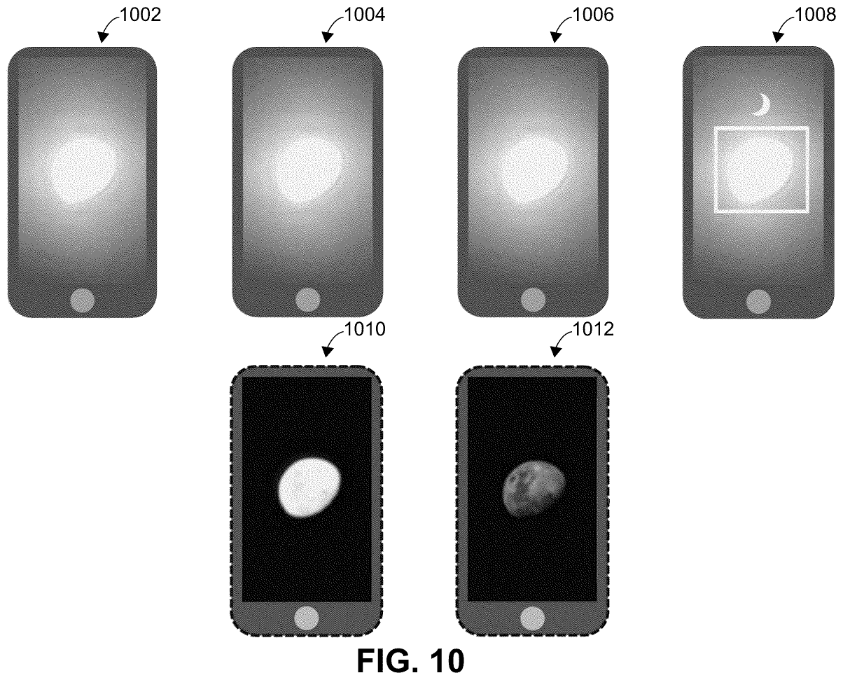

FIG. 10 includes six example images, four captured according to first image-capture settings (e.g., image 1002, image 1004, image 1006, and image 1008) and two captured according to second image-capture settings (e.g., image 1010 and image 1012), according to various aspects of the present disclosure. For example, the systems and techniques may capture image 1002, image 1004, image 1006, and image 1008 using first image-capture settings. The systems and techniques may display, transmit, process, and/or store image 1002, image 1004, image 1006, and image 1008. Image 1002, image 1004, image 1006, and image 1008 may be capture as part of a first stream of image data. The systems and techniques may capture image 1010 and image 1012 using second image-capture settings. The systems and techniques may techniques may display, transmit, process, and/or store image 1010 and image 1012.

According to an example of operations, the systems and techniques may display image 1002, image 1004, image 1006 and image 1008, for example, as they are captured. Additionally, the systems and techniques may capture image 1010 and image 1012 (e.g., using the second image-capture settings). However, the systems and techniques may not display image 1010 or image 1012. Rather, the systems and techniques may continue to display image 1002, image 1004, image 1006, and image 1008 while the systems and techniques process image 1010 and image 1012 and detect the object (e.g., the moon) in image 1012. The systems and techniques may store image 1012.

For example, the systems and techniques may capture image 1002. The systems and techniques my determine that there is a probability (beyond a threshold) that an object in image 1002 is a particular object (e.g., the moon). The systems and techniques may initiate a second stream of image data. For example, the systems and techniques may initiate the capture of image 1010 and image 1012. While capturing and displaying image 1004 and image 1006 (e.g., using a separate images sensor or in between using the same image sensor) (e.g., using the first image-capture settings), the systems and techniques may also capture image 1010 and image 1012 (e.g., using the second image-capture settings).

The systems and techniques may initiate the capture of image 1010 with image-capture settings that are relate to the image-capture settings used to capture image 1004. For example, the systems and techniques may initiate the capture of the second stream of image data using image-capture settings that are related to the image-capture settings used to capture the first stream of image data. For example, the second image-capture settings may be initiated a predetermined EV below the first image-capture settings. For instance, the initial image-capture settings of the second stream of image data may be 6 EV, 8 EV, 10 EV, 12 EV, or some other predetermined number, lower than the image-capture settings of the first stream of image data.

The systems and techniques may determine whether the particular object is present in image 1010 and image 1012. In some aspects, the systems and techniques may decrease the EV of the second stream of image data (e.g., from a first EV used to capture image 1010 to a second EV used to capture image 1012) to achieve a properly-exposed image of the particular object. For example, the systems and techniques may implement an independent AEC on the second stream of image data to iteratively adjust the image-capture settings of the second stream of image data to achieve a proper exposure of the object (e.g., the moon). In this way, the systems and techniques may determine image-capture settings for capturing images of the particular object.

In response to determining that the particular object is present, the systems and techniques may generate an indication of the presence of the particular object (e.g., a moon flag). In some aspects, the systems and techniques may provide an indication to a user. For example, in image 1008 a moon icon is displayed in the preview image 1008. In some aspects, the systems and techniques may provide the indication to other processes running on the device. The other processes may determine operations to perform (e.g., color processing, super-resolution etc.) based on the indication.

Further, in some aspects, the systems and techniques may determine a position of the particular object in images (e.g., in image 1012 and/or image 1008). The systems and techniques may display an indication (e.g., a bounding box) indicative of the position of the particular object.

In some aspects, the systems and techniques may enable the user to choose to view the second stream of image data. For example, if the user selects the moon icon, the systems and techniques may display images of the second stream of image data rather than the images of the first stream of image data.

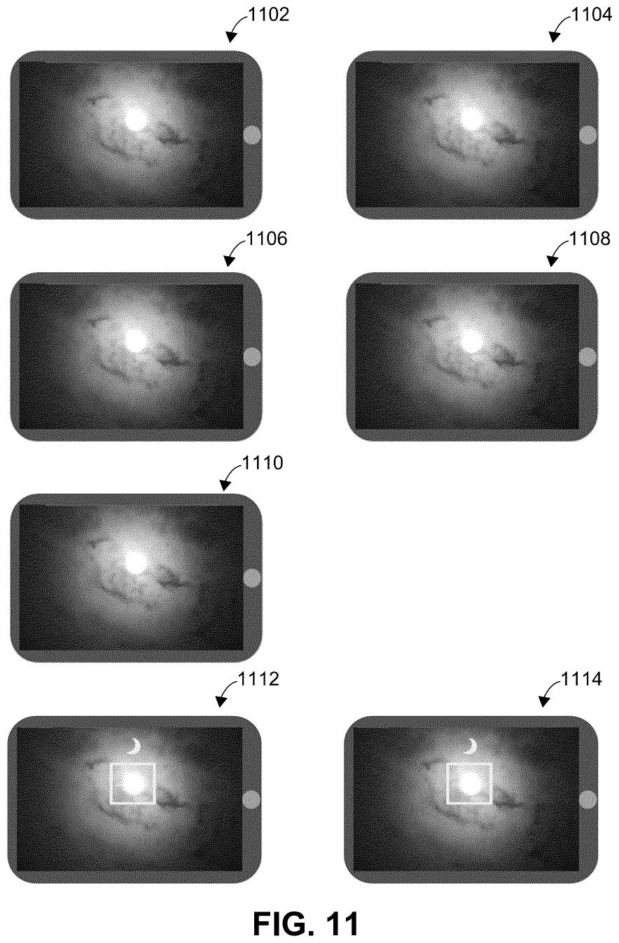

FIG. 11 includes seven example preview images, according to various aspects of the present disclosure. The seven example preview images illustrate a first example technique in which the systems and techniques may use a first stream of image data and a second stream of image data.

For example, the systems and techniques may obtain a first number of images (including image 1102 and image 1104). The systems and techniques may determine, beyond a threshold probability, that the first number of images include the particular object (e.g., the moon). For example, the systems and techniques may determine that image 1104 includes the moon. The first stream of image data may include any number of images. Two images are illustrated for descriptive purposes.

After determining that image 1104 includes the particular object, the systems and techniques may initiate capture and processing of a second stream of image data. The second stream of image data is not illustrated in FIG. 11 because, according to the first example technique, the second stream of image data is not displayed. The systems and techniques may determine (beyond a threshold probability) whether the second stream of image data includes the particular object.

During the time during which the systems and techniques determine whether the second stream of image data includes the particular object, the systems and techniques may continue to obtain images of the first stream of image data (e.g., image 1106, image 1108, and image 1110). The systems and techniques may display the images of the first stream of image data. The first stream of image data may include any number of images captured during the time between when the systems and techniques determine there is a probability that the first stream of image data includes the particular object and when the systems and techniques determine that the second stream of image data includes the particular object. Three images are illustrated for descriptive purposes.

Once the systems and techniques determine that the second stream of image data includes the particular object, the systems and techniques may display an indication that the images include the particular object. For example, image 1112 and image 1114 include an icon indicating that image 1112 and image 1114 include the moon.

According to the first example technique, the second stream of image data is not displayed. Rather the second stream of image data is captured and processed in the background while the first stream of image data is displayed.

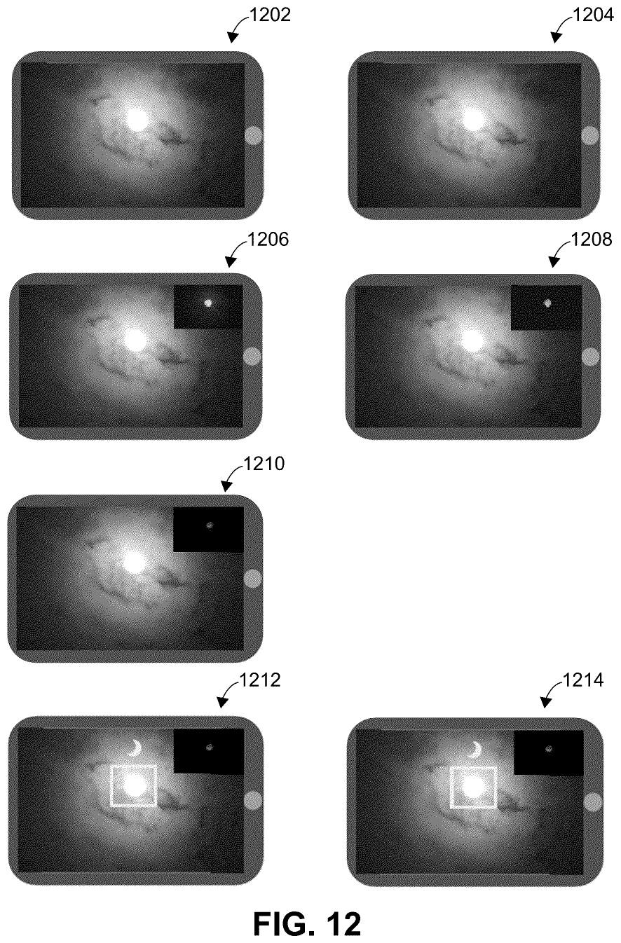

FIG. 12 includes seven example preview images, according to various aspects of the present disclosure. The seven example preview images illustrate a second example technique in which the systems and techniques may use a first stream of image data and a second stream of image data.

For example, the systems and techniques may obtain a first number of images (including image 1202 and image 1204). The systems and techniques may determine, beyond a threshold probability, that the first number of images include the particular object (e.g., the moon). For example, the systems and techniques may determine that image 1204 includes the moon.

After determining that image 1204 includes the particular object, the systems and techniques may initiate capture and processing of a second stream of image data. The systems and techniques may determine (beyond a threshold probability) whether the second stream of image data includes the particular object. During the time during which the systems and techniques determine whether the second stream of image data includes the particular object, the systems and techniques may continue to obtain images of the first stream of image data.

According to the second example technique, the systems and techniques may display images of both the first stream of image data and the second stream of image data. For example, the systems and techniques may display images of the first stream of image data full-size in the display and display reduced-size (e.g., thumbnail) images of the second stream of image data. For example, image 1206, image 1208, and image 1210 include images of the first stream of image data and thumbnails of images of the second stream of image data.

Once the systems and techniques determine that the second stream of image data includes the particular object, the systems and techniques may display an indication that the images include the particular object. For example, image 1212 and image 1214 include an icon indicating that image 1212 and image 1214 include the moon. Additionally, if the systems and techniques determine that the images include the particular object, the systems and techniques may continue to display images of the second stream of image data (e.g., as thumbnails). For example, image 1212 and image 1214 include thumbnails of the second stream of image data.

According to the second example technique, the second stream of image data is displayed along with the first stream of image data. The second stream of image data is captured and processed in the background while the first stream of image data and the second stream of image data are displayed together.

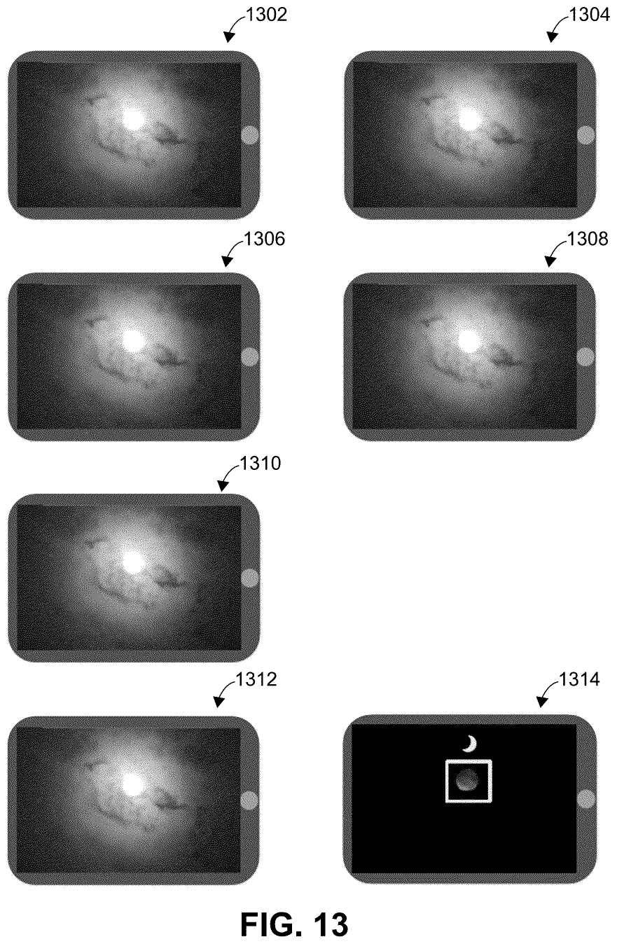

FIG. 13 includes seven example preview images, according to various aspects of the present disclosure. The seven example preview images illustrate a third example technique in which the systems and techniques may use a first stream of image data and a second stream of image data.

For example, the systems and techniques may obtain a first number of images (including image 1302 and image 1304). The systems and techniques may determine, beyond a threshold probability, that the first number of images include the particular object (e.g., the moon). For example, the systems and techniques may determine that image 1304 includes the moon.

After determining that image 1304 includes the particular object, the systems and techniques may initiate capture and processing of a second stream of image data. The second stream of image data is not illustrated in FIG. 13 because according to the third example technique, the second stream of image data is not initially displayed. The systems and techniques may determine (beyond a threshold probability) whether the second stream of image data includes the particular object.

During the time during which the systems and techniques determine whether the second stream of image data includes the particular object, the systems and techniques may continue to obtain images of the first stream of image data (e.g., image 1306, image 1308, image 1310 and image 1312). The systems and techniques may display the images of the first stream of image data.

Once the systems and techniques determine that the second stream of image data includes the particular object, the systems and techniques may display images of the second stream of image data. For example, the systems and techniques may display image 1314 which may be of the second stream of image data. The systems and techniques may continue to capture and process both the first stream of image data and the second stream of image data.

According to the third example technique, before the systems and techniques determine that the images include the particular object, the second stream of image data is captured and processed in the background while the first stream of image data is displayed. The systems and techniques display the second stream of image data after the systems and techniques determine that the images include the particular object.

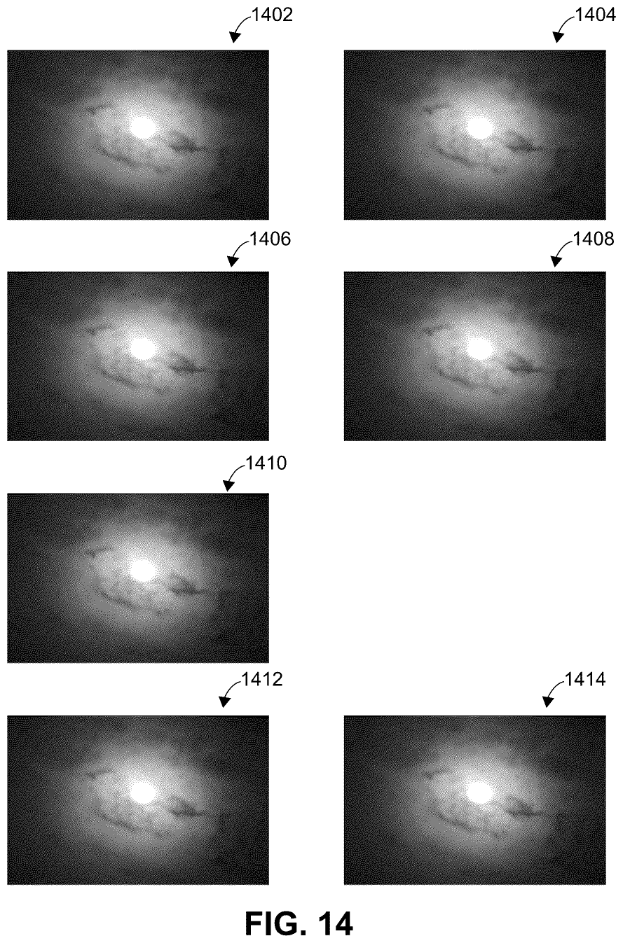

FIG. 14 includes seven example images of a first stream of image data, according to various aspects of the present disclosure. The seven images of FIG. 14 (e.g., image 1402, image 1404, image 1406, image 1408, image 1410, image 1412, and image 1414) may be captured according to an AEC mode of operation. Image 1402, image 1404, image 1406, image 1408, image 1410, image 1412, and image 1414 may be the first stream of image data used in the example process described relative to FIG. 11, FIG. 12, and FIG. 13.

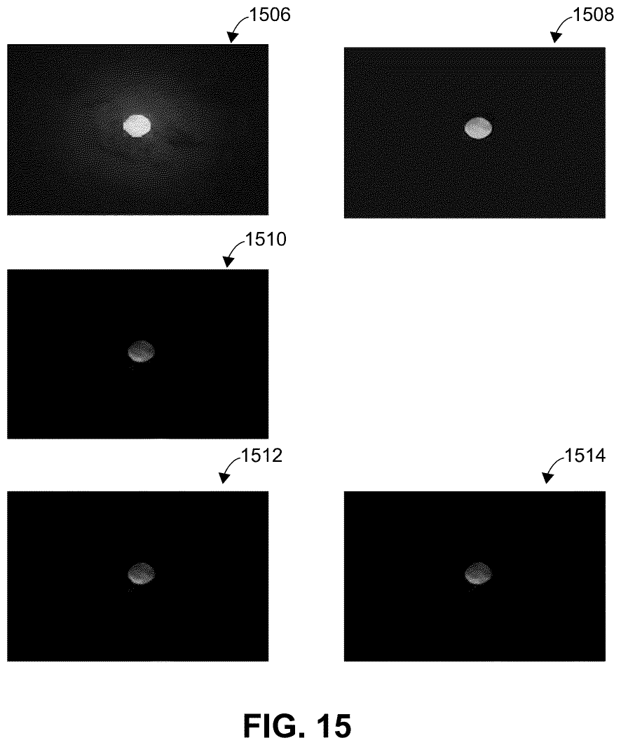

FIG. 15 includes five example images of a second stream of image data, according to various aspects of the present disclosure. The five images of FIG. 15 (e.g., image 1506, image 1508, image 1510, image 1512, and image 1514) may be captured according to an object-detection mode of operation. Image 1506, image 1508, image 1510, image 1512, and image 1514 may be the second stream of image data used in the example process described relative to FIG. 11, FIG. 12, and FIG. 13. There are five images in FIG. 15 because, according to the example process described relative to FIG. 11, FIG. 12, and FIG. 13, the second stream of image data is initiated only after determining that the first number of images have a probability (beyond a threshold) of including the particular object.

The systems and techniques may provide a smooth convergence for images of the particular object. For example, the systems and techniques may converge on image-capture settings for capturing images of the particular object without displaying images as the image-capture settings are iteratively determined (e.g., as illustrated and described with regard to FIG. 7 and FIG. 8). For example, the systems and techniques may present a properly-exposed image of the particular object (e.g., image 1314 of FIG. 13) (either in response to detecting the particular object or in response to a user input) after the image-capture settings have converged without displaying underexposed and/or overexposed images captured while the image-capture settings are being adjusted.

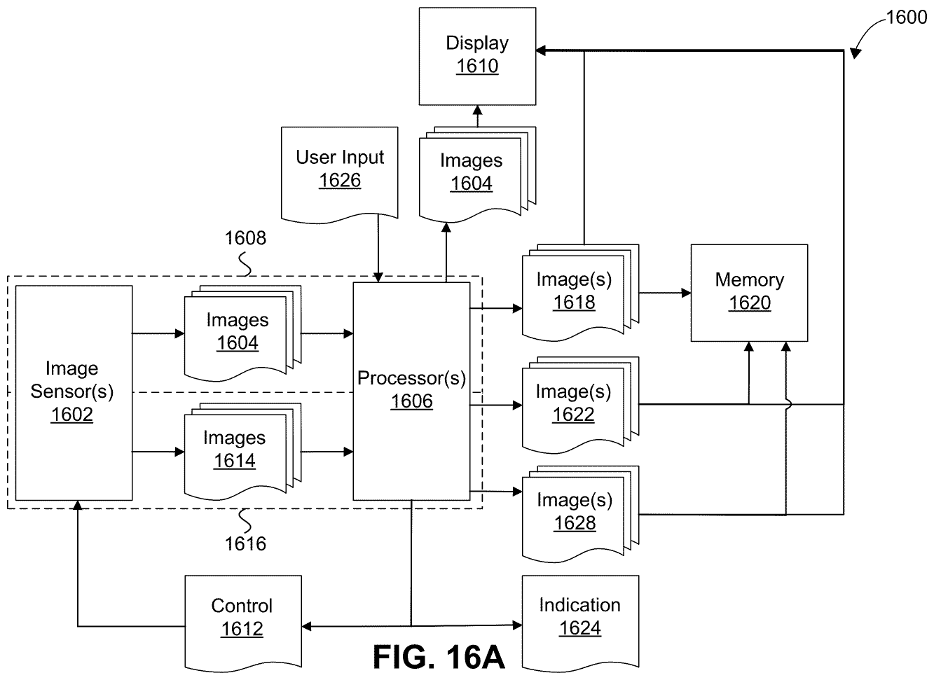

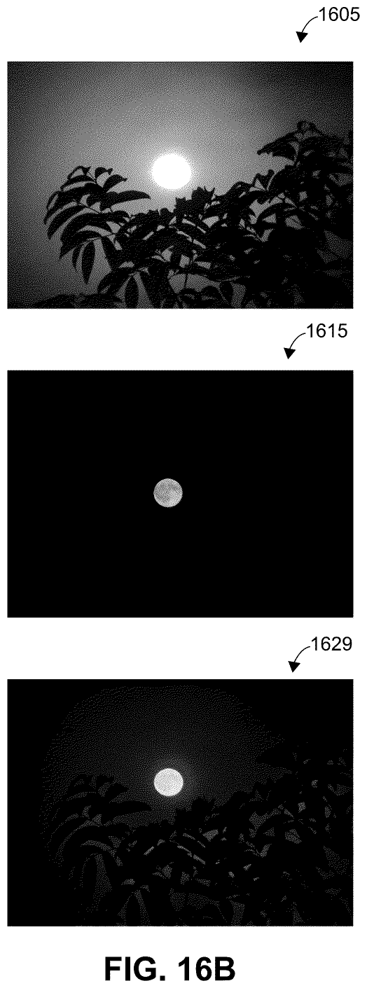

FIG. 16A is a block diagram of an example system 1600 for imaging, according to various aspects of the present disclosure. In general, image sensor(s) 1602 may capture a first series of images (“images 1604”). Processor(s) 1606 may provide images 1604 to display 1610. Additionally, processor(s) 1606 may determine a probability that images 1604 include a particular object (e.g., the moon). In response to the probability exceeding a threshold, processor(s) 1606 may cause image sensor(s) 1602 to capture a second series of images (“images 1614”). Processor(s) 1606 may store one or more image(s) 1622 from among images 1614 in memory 1620.

Image sensor(s) 1602 may be, or may include, one or more image sensors. In some aspects, image sensor(s) 1602 may include a single image sensor capable of capturing image data using different image-capture settings for separate images. For example, the single images sensor may be capable of capturing sequential frames of a series of frames using different image-capture settings for every other frame, for example, as illustrated by image 902, image 904, image 906, and image 908 of FIG. 9. Such an image sensor may also be capable of maintaining a particular frame rate for one or both of the streams of image data. For example, image sensor(s) 1602 may capture image 902, image 906, and every other subsequent images at a frame rate of 30 frames per second (fps). Also, image sensor(s) 1602 may capture image 904, image 908, and every other subsequent frame at a rate of 30 fps.

In other aspects, image sensor(s) 1602 may include two (or more) separate image sensors. Each of the image sensors may capture images separately. The image sensors may be positioned proximate to one another (e.g., on a body of a device). For example, a device may include two telephoto lenses and corresponding image sensors on a back surface of the device, for example, opposite display 1610.

Images 1604 may be, or may include, a first series of image frames. Images 1604 may include any number of image frames captured according to first image-capture settings. The first image-capture settings may change over time (e.g., responsive to automatic exposure control (AEC)). For example, a first image of images 1604 may be captured according to a first EV and a second image of images 1604 may be captured according to a second EV based on changed lighting in the scene or to cause the exposure to be more appropriate to the scene. Images 402 of FIG. 4, image 902 and image 906 of FIG. 9, image 1002, image 1004, image 1006, and image 1008 of FIG. 10, image 1402, image 1404, image 1406, image 1408, image 1410, image 1412, and image 1414 of FIG. 14 may be examples of images 1604.

Processor(s) 1606 may be, or may include, one or more processors, such as central processing units (CPUs), graphics processing units (GPUs), or other processors. Processor(s) 1606 may obtain images 1604 (e.g., receive images 1604 from image sensor(s) 1602). Image sensor(s) 1602 providing images 1604 to processor(s) 1606 may be referred to as a first stream of image data (“stream 1608”).

Processor(s) 1606 may determine a probability that any of images 1604 includes a particular object. For example, processor(s) 1606 may implement an object detector that may determine the probability that each image of images 1604 represents the particular object.

Additionally, in some aspects, processor(s) 1606 may provide images 1604 to display 1610 for display. Display 1610 may display images to a user that is pointing image sensor(s) 1602 toward a scene to capture images of the scene. For example, display 1610 may be on an opposite surface of the device as image sensor(s) 1602.

Processor(s) 1606 may determine a probability that one or more of images 1604 includes the particular object and, the probability exceeding a threshold, processor(s) 1606 may send a control message (control 1612) to image sensor(s) 1602. Control 1612 may instruct image sensor(s) 1602 to initiate capture of images 1614.

In response to control 1612, image sensor(s) 1602 may initiate the capture of images 1614. Images 1614 may be, or may include, a second series of image frames. Images 1614 may include any number of image frames captured according to second image-capture settings. The second image-capture settings may be different than the first image-capture settings. Control 1612 may include the second image-capture settings (and/or the first image-capture settings). Processor(s) 1606 may determine the second image-capture settings based on the first image-capture settings, for example, to be a predetermined EV (e.g., 6 EV, 8 EV, 10 EV, or 12 EV) lower than the first image-capture settings. Processor(s) 1606 may change the second image-capture settings may over time (e.g., according to an AEC algorithm to properly expose the particular object in images 1614). Processor(s) 1606 may iteratively change the second image-capture settings to achieve a proper exposure of the particular object. Images 412 of FIG. 4, image 904 and image 908 of FIG. 9, image 1010 and image 1012 of FIG. 10, image 1506, image 1508, image 1510, image 1512, and image 1514 may be examples of images 1614. Image sensor(s) 1602 providing images 1614 to processor(s) 1606 may be referred to as a second stream of image data (“stream 1616”).

Processor(s) 1606 may detect the particular object in images 1614. For example, processor(s) 1606 may include an object detector that may detect the particular object in images 1614. Processor(s) 1606 may perform one or more operations based on determining that images 1614 includes the particular object.

For example, in some aspects, processor(s) 1606 may generate an indication 1624 indicating that images 1614 includes the particular object. Indication 1624 may trigger additional processing. In some aspects, indication 1624 may be a trigger internal to processor(s) 1606. Additionally or alternatively, indication 1624 may be provided to one or more other processors that may perform operations based on indication 1624. For example, system 1600 (or another system or device) may display an indication or icon based on indication 1624. The moon flag referenced with regard to FIG. 6 may be an example of indication 1624. The icon displayed in any of image 908 of FIG. 9, image 1008 of FIG. 10, image 1112 and image 1114 of FIG. 11, image 1212 and image 1214 of FIG. 12, image 1314 of FIG. 13 may be displayed based on indication 1624. For example, indication 1624 may be a trigger to cause processor(s) 1606 to cause display 1610 to display image 1112 and image 1114 with the icons, to display image 1212 and image 1214 with the icons, and/or to display image 1314.

Additionally or alternatively, based on determining that images 1614 includes the particular object, processor(s) 1606 may cause display 1610 to display one or more image(s) 1622 from among images 1614. For example, processor(s) 1606 may cause display 1610 to display image(s) 1622 from among images 1614 as thumbnails along with images 1604, (e.g., as illustrated and described with regard to FIG. 12). As another example, processor(s) 1606 may cause display 1610 to display image(s) 1622 from among images 1614 instead of images 1604 (e.g., as illustrated and described with regard to FIG. 13).

In some aspects, responsive to determining that images 1614 includes the particular object, processor(s) 1606 may store one or more image(s) 1622 from among images 1614 in memory 1620. For example, in some cases, processor(s) 1606 may be storing one or more image(s) 1618 from among images 1604 in memory 1620 (e.g., as a series of images of video data). Based on determining that images 1614 includes the particular object, processor(s) 1606 may store image(s) 1622 in memory as well. Additionally or alternatively, based on determining that images 1614 includes the particular object processor(s) 1606 may generate composite image(s) 1628 based on images 1604 and images 1614 (e.g., HDR images) and store composite image(s) 1628 in memory 1620.

FIG. 16B includes a first example image 1605 captured according to first image-capture settings, a second example image 1615 captured according to second image-capture settings, and a composite image 1629 generated based on image 1605 and image 1615. Image 1629 may include pixels representing the moon from second example image 1615 and pixels representing other portions of the scene (e.g., the sky and the tree) from first example image 1605.

Returning to FIG. 16A, image(s) 1622 may represent a subset of images 1614. For example, image(s) 1622 may be, or may include, images of images 1614 that are received by processor(s) 1606 after processor(s) 1606 determines that at least one of images 1614 represents the particular object. Image(s) 1618 may be, or may include, a subset of images 1604. In some aspects, processor(s) 1606 may modify images 1604 to generate image(s) 1618 and/or may modify images 1614 to generate image(s) 1622. For example, processor(s) 1606 may perform image processing on images 1604 and/or images 1614, for example, for noise reduction.

In some aspects, processor(s) 1606 may receive a user input 1626 and perform one or more operations based on user input 1626 and based on determining that images 1614 includes the particular object. For example, processor(s) 1606 may receive user input 1626 indicating capturing or storing an image. For instance, a user may be pointing image sensor(s) 1602 at a scene and viewing images 1604 of the scene at display 1610 while composing a shot. The user may press a shutter button, or otherwise indicate their desire to capture an image. Processor(s) 1606 may receive user input 1626 which may be, or may include, an indication that the user pressed the shutter button. Additionally or alternatively, the user may press a record button indicating that the user wants to capture a series of images (e.g., a video). User input 1626 may be, or may include, an indication that the user pressed the record button.

Image(s) 1618 may be, or may include, one or more of images 1604 that is selected based on user input 1626. Additionally or alternatively, image(s) 1622 may be, or may include, one or more of images 1614 that is selected based on user input 1626. For example, image(s) 1618 may be, or may include, all of images 1604 that are received after processor(s) 1606 receives user input 1626 and image(s) 1622 may be, or may include, all of images 1614 that are received after processor(s) 1606 receives user input 1626.

For example, processor(s) 1606 may determine that images 1614 includes the particular object. Processor(s) 1606 may, or may not, perform any operation in response to determining that images 1614 includes the particular object. For example, processor(s) 1606 may, or may not, output indication 1624, provide image(s) 1622 to display 1610, and/or store image(s) 1622 in response to determining that images 1614 includes the particular object. However, in response to processor(s) 1606 receiving user input 1626 and processor(s) 1606 determining that images 1614 includes the particular object, processor(s) 1606 may store image(s) 1618 and/or image(s) 1622 in memory 1620, generate one or more composite image(s) 1628 based on image(s) 1618 and image(s) 1622, store and/or display the composite image(s) 1628, and/or output indication 1624.

As an example of contemplated operations of system 1600, a user may be pointing image sensor(s) 1602 at a scene. Image sensor(s) 1602 may provide images 1604 to processor(s) 1606. Processor(s) 1606 may provide images 1604 to display 1610 for display. Processor(s) 1606 may determine a probability that images 1604 includes a particular object. Based on the probability exceeding a threshold, processor(s) 1606 may instruct image sensor(s) 1602 to capture images 1614. Image sensor(s) 1602 may capture images 1614. Processor(s) 1606 may determine whether images 1614 includes the particular object. In some aspects, based on determining that images 1614 includes the particular object, processor(s) 1606 may output indication 1624. In some aspects, display 1610 may display an indication (e.g., an icon or text) based on indication 1624 (e.g., as illustrated and described with regard to FIG. 10, FIG. 11, and/or FIG. 12). Additionally or alternatively, processor(s) 1606 may provide image(s) 1622 to display 1610 for display (e.g., as thumbnail images as illustrated by FIG. 12). The user may view the icon and/or thumbnail.

Continuing the example, the user may press a shutter button or a record button, which may cause processor(s) 1606 to receive user input 1626. Image(s) 1618 may be, or may include, all of images 1604 received by processor(s) 1606 after processor(s) 1606 receives user input 1626 and image(s) 1622 may be, or may include, all of images 1614 received by processor(s) 1606 after processor(s) 1606 receives user input 1626. Based on processor(s) 1606 receiving user input 1626 and based on processor(s) 1606 determining that images 1614 includes the particular object, processor(s) 1606 may store image(s) 1618 and/or image(s) 1622 at memory 1620, generate composite image(s) 1628 based on image(s) 1618 and image(s) 1622 and store the composite image(s) 1628, and/or provide the composite image(s) 1628 to display 1610 for display.

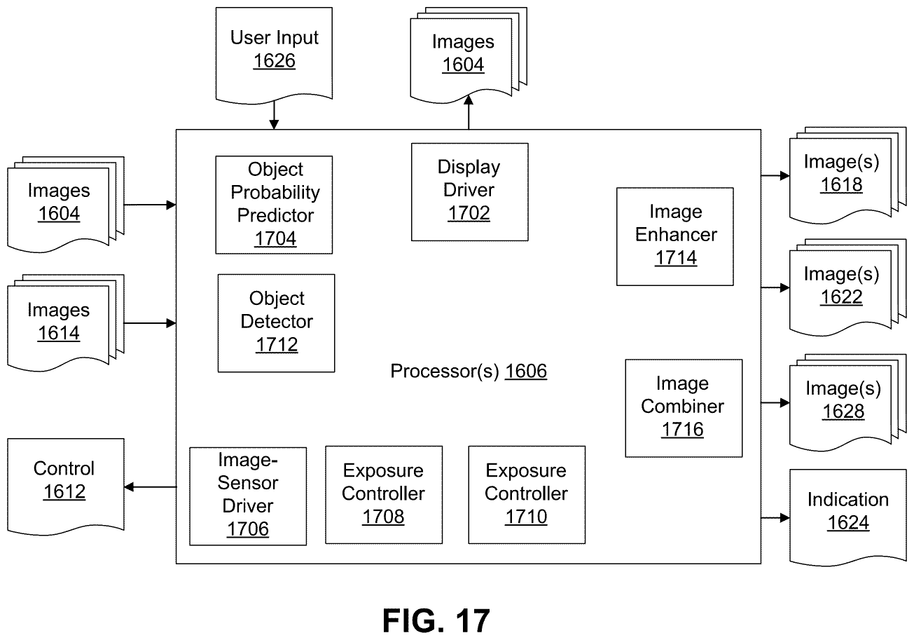

FIG. 17 is a block diagram illustrating processor(s) 1606 of FIG. 16A, according to various aspects of the present disclosure. In FIG. 17, Processor(s) 1606 is illustrated including a number of elements representative of various operations that may be performed by processor(s) 1606. The elements are representative of processes, modules, routines, algorithms, etc. implemented by processor(s) 1606. For example, a display driver 1702 of processor(s) 1606 may format and/or condition images 1604, image(s) 1618, image(s) 1622, and/or image(s) 1628 for display by images 1604.

An object probability predictor 1704 of processor(s) 1606 may determine a probability that images 1604 includes a particular object. Object probability predictor 1704 may output a numerical value indicative of a probability that images 1604 includes the particular object. Additionally or alternatively, object probability predictor 1704 may determine whether images 1604 includes the particular object and generate a numerical value indicative of a confidence of object probability predictor 1704 relative to the determination.

In some aspects, object probability predictor 1704 may determine the probability based on characteristics of a detected object in images 1604. For example, object probability predictor 1704 may operate based on a moon-size heuristic which may use a zoom ratio, camera intrinsics, a size the detected object in images 1604, and predefined moon-size data. Additionally or alternatively, object probability predictor 1704 may operate based on brightness of a detected spotlight in images 1604. For example, object probability predictor 1704 may compare a ratio of the brightness of the detected spotlight to predefined moon brightness data.

In some aspects, object probability predictor 1704 may be, or may include, a machine-learning model trained to detect the particular object in images. For example, object probability predictor 1704 may include a machine-learning model trained to detect the moon in images. A machine-learning model may be particularly useful in cases in which in images 1604, the moon is not full (e.g., when the moon is in a crescent or half phase).

An exposure controller 1708 of processor(s) 1606 may generate control 1612 for controlling image-capture settings of image sensor(s) 1602 used for capturing images 1604. Exposure controller 1708 may implement AEC based on images 1604.

An exposure controller 1710 of processor(s) 1606 may generate control 1612 for controlling image-capture settings of image sensor(s) 1602 used for capturing images 1614. Exposure controller 1710 may implement exposure control based on the particular object. For example, exposure controller 1710 adjust the image-capture settings used by image sensor(s) 1602 to capture images 1614 such that the particular object is properly exposed in images 1614. Exposure controller 1710 may adjust the image-capture settings for capturing images 1614 separately from the operations of exposure controller 1708 to adjust image-capture settings for capturing images 1604.

In some aspects, exposure controller 1708 and exposure controller 1710 may be separate modules, routines, algorithms, etc. operating in parallel. For example, exposure controller 1708 may operate on images 1604 to control image-capture settings for images 1604 and exposure controller 1710 may operate on images 1614 to control image-capture settings for images 1614. In other aspects, a single exposure controller may control image-capture settings for both images 1604 and images 1614.

An image-sensor driver 1706 of processor(s) 1606 may generate control 1612 based on instructions from exposure controller 1708 and/or exposure controller 1710. Image-sensor driver 1706 may format and/or condition instructions of exposure controller 1708 and exposure controller 1710 as control 1612.

An object detector 1712 of processor(s) 1606 may determine whether images 1614 includes the particular object. Object detector 1712 may be, or may include, a machine-learning model trained to detect the particular object in images. In some aspects, object detector 1712 may generate numerical values indicating respective probabilities that images 1614 includes the particular object. In some aspects, if one or more of the probabilities is greater than a probability threshold, object detector 1712 may be said to have determined that images 1614 includes the particular object. In some aspects, object detector 1712 may be the same as, may be substantially similar to, and/or may perform the same, or substantially the same, operations as object probability predictor 1704.

In some aspects, the threshold used by processor(s) 1606 to determine to initiate the capture of images 1614 may be less than the threshold used by processor(s) 1606 to determine that images 1614 includes the particular object. For example, object probability predictor 1704 may determine a first probability that images 1604 includes the particular object. Processor(s) 1606 may initiate the capture of images 1614 based on the first probability exceeding a first threshold. Additionally, object detector 1712 may determine a second probability that images 1614 includes the particular object. Processor(s) 1606 may perform a number of operations (such as outputting indication 1624, generating image(s) 1628, storing image(s) 1622, storing image(s) 1628, etc.) based on the second probability exceeding a second threshold. The second threshold may be higher than the first threshold.

An image enhancer 1714 of processor(s) 1606 may enhance image(s) 1618, image(s) 1622, and/or image(s) 1628. Image enhancer 1714 may reduce noise of, balance colors of, white-balance, etc. image(s) 1618, image(s) 1622, and/or image(s) 1628. Image enhancer 1714 may implement one or more machine-learning models trained to enhance images.

An image combiner 1716 of processor(s) 1606 may generate composite image(s) 1628 based on image(s) 1618 and/or image(s) 1622. For example, image combiner 1716 may generate HDR images based on image(s) 1618 and image(s) 1622. Additionally or alternatively, image combiner 1716 may generate super-resolution images based on image(s) 1622.

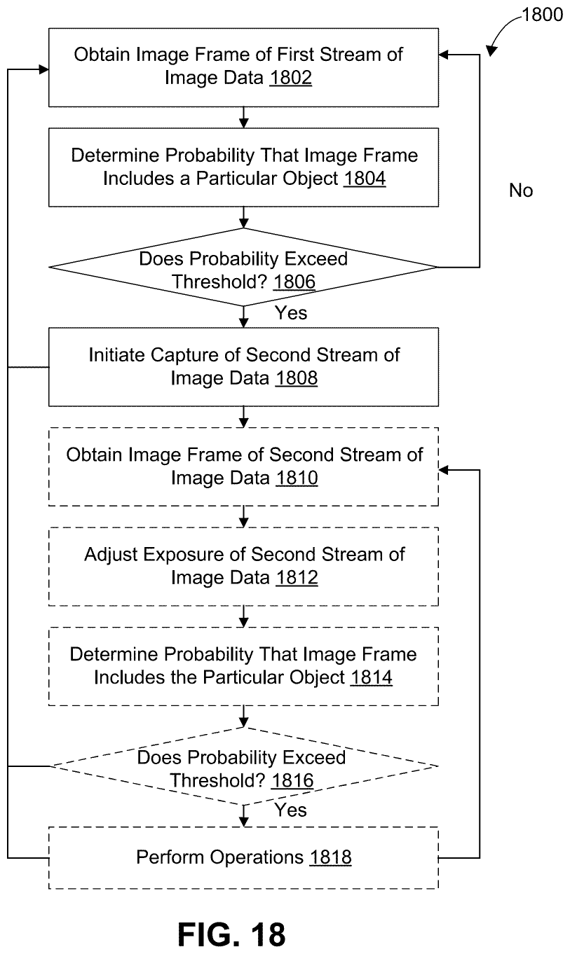

FIG. 18 includes a flow diagram illustrating a process 1800 for imaging, according to various aspects of the present disclosure. System 1600 of FIG. 16A or processor(s) 1606 of FIG. 16A and FIG. 17 may implement process 1800.

At block 1802, processor(s) 1606 may obtain an image frame of a first stream of image data. For example, processor(s) 1606 may obtain an image of images 1604.

At block 1804, processor(s) 1606 may determine a probability that the image frame obtained at block 1802 includes a particular object. For example, object probability predictor 1704 of processor(s) 1606 may determine a probability that the image obtained at block 1802 includes the particular object (e.g., the moon).

At decision block 1806, processor(s) 1606 may determine whether the probability determined at block 1804 exceeds a probability threshold. If the probability does not exceed the probability threshold, process 1800 may return to block 1802. At block 1802, processor(s) 1606 may receive an additional image frame of the first stream of image data (e.g., a second frame of images 1604). If the probability exceeds the probability threshold, process 1800 may continue to block 1808.

At block 1808, processor(s) 1606 may initiate capture of a second stream of image data. For example, processor(s) 1606 may instruct image sensor(s) 1602 to capture images 1614. In some aspects, process 1800 may proceed from block 1808 to block 1802 at which point processor(s) 1606 may receive additional images of the first stream of image data. Processor(s) 1606 may continue to determine probabilities regarding whether the additional images include the particular object (e.g., at block 1804) and continue determining whether to keep the second stream of image data active based on the additional images of the first stream of image data (e.g., at decision block 1806). In other aspects, processor(s) 1606 may continue to receive images of the first stream of image data but may condition maintaining the second stream of image data based on the probability (or determination) that the second stream of image data includes the particular object (e.g., determined at decision block 1816). In either case, process 1800 may proceed to block 1810.

At block 1810, decision block 1806 may obtain an image frame of the second stream of image data. For example, processor(s) 1606 may obtain an image of images 1614.

At block 1812, processor(s) 1606 may adjust an exposure of the second stream of image data. For example, exposure controller 1710 of processor(s) 1606 may adjust the image-capture settings used by image sensor(s) 1602 to capture images 1614.

At block 1814, processor(s) 1606 may determine a probability the image obtained at block 1810 includes the particular object. For example, object detector 1712 of processor(s) 1606 may determine a probability one of images 1614 includes the particular object.

At decision block 1816, processor(s) 1606 may determine whether the probability determined at block 1814 exceeds a probability threshold. If the probability does not exceed the probability threshold, process 1800 may return to block 1802. At block 1802, processor(s) 1606 may receive an additional image frame of the first stream of image data (e.g., a second frame of images 1604). If the probability exceeds the probability threshold, process 1800 may continue to block 1818.

At block 1818, processor(s) 1606 may perform operations. For example, processor(s) 1606 may output indication 1624, store image(s) 1622, display image(s) 1622, process image(s) 1622, enhance image(s) 1622, and/or generate image(s) 1628 based on image(s) 1622 and image(s) 1618.

Additionally or alternatively, following decision block 1816, process 1800 may await user input 1626. For example, at block 1818 processor(s) 1606 may await user input 1626 before performing one or more operations. For example, at block 1818, processor(s) 1606 may output indication 1624 and, await user input 1626 before storing image(s) 1622, displaying image(s) 1622, processing image(s) 1622, enhancing image(s) 1622, and/or generating image(s) 1628 based on image(s) 1622 and image(s) 1618.

Following block 1818, process 1800 may continue receiving images of the first stream of image data and images of the second stream of image data. For example, process 1800 may continue to receive images of the second stream of image data and continue to adjust image-capture settings of the second stream of image data at block 1812.

Although not illustrated in FIG. 18, in some aspects, process 1800 may implement hysteresis at one or more points in process 1800. For example, in some aspects, if a probability that a first frame of the second stream of image data exceeds the probability threshold at decision block 1816, and a probability that a second frame of the second stream of image data does not exceed the probability threshold at decision block 1816, process 1800 may return to block 1810, block 1812, block 1814, and decision block 1816 to determine whether a probability of a third frame of the second stream of image data exceeds the threshold.

Some of the blocks of FIG. 18 may run in the background, for example, without providing an output to a user. Such blocks are illustrated in FIG. 18 using dashed lines. For example, block 1810, block 1812, block 1814, decision block 1816, and block 1818 may run in the background without displaying images of the second stream of image data at a display. Block 1818 may, or may not, involve displaying images of the second stream of image data at the display.

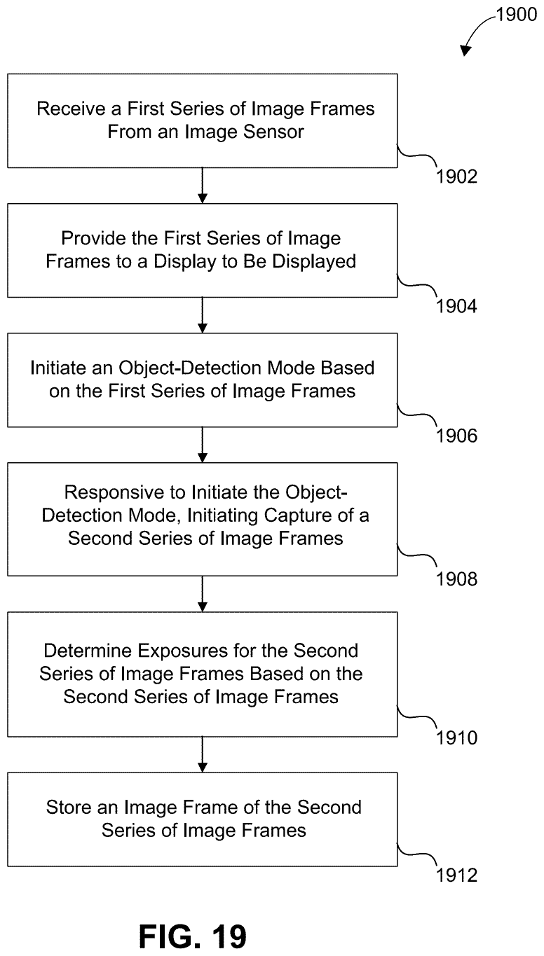

FIG. 19 is a flow diagram illustrating an example process 1900 for imaging, in accordance with aspects of the present disclosure. One or more operations of process 1900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1900. The one or more operations of process 1900 may be implemented as software components that are executed and run on one or more processors.

At block 1902, a computing device (or one or more components thereof) may receive a first series of image frames from an image sensor. For example, processor(s) 1606 of FIG. 16A may receive images 1604 (e.g., of stream 1608) from sensor(s) 1602.

At block 1904, the computing device (or one or more components thereof) may provide the first series of image frames to a display to be displayed. For example, processor(s) 1606 may provide images 1604 to display 1610 to be displayed.

At block 1906, the computing device (or one or more components thereof) may initiate an object-detection mode based on the first series of image frames. For example, processor(s) 1606 may initiate an object-detection mode.

In some aspects, the object-detection mode may be initiated responsive to a confidence value indicative that a particular object is represented in the first series of images exceeding a confidence threshold. For example, a 1704// of FIG. 17 may determine a confidence value indicative of whether 1604// include a particular object (e.g., the moon). The object-detection mode may be initiated based on the confidence value exceeding a confidence threshold.

In some aspects, the particular object may be the moon. In some aspects, the object-detection mode may be a moon-detection mode.

At block 1908, the computing device (or one or more components thereof) may, responsive to initiating the object-detection mode, initiate capture of a second series of image frames. For example, responsive to initiating the object-detection mode (at block 1906), processor(s) 1606 may initiate capture of images 1614. For example, processor(s) 1606 may instruct sensor(s) 1602 to begin capturing images 1614.

In some aspects, the capture of the second series of image frames is initiated with an exposure value that is different from an exposure value of the first series of image frames. For example, the capture of images 1614 may be initiated with an exposure value that is different than the exposure value used to capture images 1604.

In some aspects, the exposure value with which the second series of images frames is initiated is a predetermined amount lower than the exposure value of the first series of image frames. For example, the exposure value with which the capture of images 1614 is initiated may be a predetermined value (e.g., 6, 8, 10, or 12, EV) lower than the exposure value that is currently being used to capture images 1604.

In some aspects, the second series of image frames may be captured by the image sensor. For example, images 1604 and images 1614 may be captured by the same image sensor of sensor(s) 1602. In some aspects, images 1604 and images 1614 may be captured in an interleaved fashion as described with regard to FIG. 9.

In some aspects, the image sensor comprises a first image sensor and wherein the second series of image frames is captured by a second image sensor. For example, images 1604 may be captured by an image sensor of sensor(s) 1602 and images 1614 may be captured by another images sensor of sensor(s) 1602.

At block 1910, the computing device (or one or more components thereof) may determine exposures for the second series of image frames based on the second series of image frames. For example, processor(s) 1606 may determine exposures for images 1614 based on images 1614. For instance, processor(s) 1606 may determine exposure times for images 1614 separately from the exposure times determined for images 1604.

At block 1912, the computing device (or one or more components thereof) may store an image frame of the second series of image frames. For example, processor(s) 1606 may store at least one of image(s) 1622 in memory 1620.

In some aspects, the image frame is stored based on a user input. For example, processor(s) 1606 may (at block 1912) store the at least one of image(s) 1622 based on user input 1626. For example, a user may press a shutter button and processor(s) 1606 may store the at least one of image(s) 1622 responsive to the user pressing the shutter button.

In some aspects, the user input is received while a first image frame of the first series of image frames is displayed by the display. For example, display 1610 may be displaying images 1604 when user input 1626 is received (e.g., when the shutter button is pressed).

In some aspects, while the image frame is captured and stored, the first series of image frames is provided to the display to be displayed. For example, while processor(s) 1606 captures and stores image(s) 1622, processor(s) 1606 may provide images 1604 to display 1610.

In some aspects, the computing device (or one or more components thereof) may provide the image frame to the display to be displayed. For example, processor(s) 1606 may provide image(s) 1622 to display 1610. For example, responsive to receiving user input 1626, processor(s) 1606 may provide image(s) 1622 to display 1610.

In some aspects, the computing device (or one or more components thereof) may generate a composite image based on the image frame of the second series of image frames and an image frame of the first series of image frames. For example, processor(s) 1606 may generate composite image(s) 1628 based on images 1604 and images 1614. As another example, processor(s) 1606 may generate composite image 1629 based on first example image 1605 and second example image 1615.

In some aspects, the composite image may be, or may include, pixels representing an object detected by the object-detection mode from the image frame of the second series of image frames and pixels representing a remainder of a scene from the image frame of the first series of image frames. For example, composite image(s) 1628 may be, or may include, a composite image including pixels representing the moon from images 1614 and other pixels (e.g., representing everything else in the image frame) from images 1604. For example, processor(s) 1606 may generate composite image 1629 based on first example image 1605 and second example image 1615.

In some aspects, the composite image comprises pixels representing the image frame of the second series of image frames inset into the image frame of the first series of image frames. For example, composite image(s) 1628 may be, or may include, images 1614 inset into images 1604 (e.g., in a picture-in-picture fashion, for example, as illustrated in FIG. 12).

In some aspects, the computing device (or one or more components thereof) may provide the composite image to the display to be displayed. For example, processor(s) 1606 may provide composite image(s) 1628 (or composite image 1629) to display 1610. For example, rather than displaying a box and/or icon indicating the presence of the object (e.g., as in image 1112), display 1610 may display the composite image. In some cases, display 1610 may display the composite image instead of images of the first stream. In some cases, display 1610 may display the composite image inset into images of the first stream (e.g., in a picture-in-picture fashion, for example, as illustrated in FIG. 12).

In some aspects, the composite image may be displayed prior to a user input associated with capturing an image. For example, processor(s) 1606 may provide composite image(s) 1628 to display 1610 and display 1610 may display composite image(s) 1628 prior to system 1600 receiving user input 1626. For example, display 1610 may display composite image 1629 as a preview image before a shutter button is pressed.

In some aspects, the composite image may be displayed responsive to a user input associated with capturing an image. For example, processor(s) 1606 may provide composite image(s) 1628 to display 1610 and display 1610 may display composite image(s) 1628 responsive to system 1600 receiving user input 1626. For example, display 1610 may display composite image 1629 after a shutter button is pressed.

In some aspects, the computing device (or one or more components thereof) may include the image sensor. In some aspects, the computing device (or one or more components thereof) may include the display.

In some aspects, the image of the second series of image frames may be stored, displayed, transmitted, enhanced, and/or processed.

In some examples, as noted previously, the methods described herein (e.g., process 1800 of FIG. 18, process 1900 of FIG. 19, and/or other methods described herein) can be performed, in whole or in part, by a computing device or apparatus. In one example, one or more of the methods can be performed by system 1600 of FIG. 16A, processor(s) 1606 of FIG. 16A and FIG. 17, or by another system or device. In another example, one or more of the methods (e.g., process 1800, process 1900, and/or other methods described herein) can be performed, in whole or in part, by the computing-device architecture 2200 shown in FIG. 22. For instance, a computing device with the computing-device architecture 2200 shown in FIG. 22 can include, or be included in, the components of the system 1600 and/or image sensor(s) 1602 and can implement the operations of process 1800, process 1900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1800, process 1900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1800, process 1900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

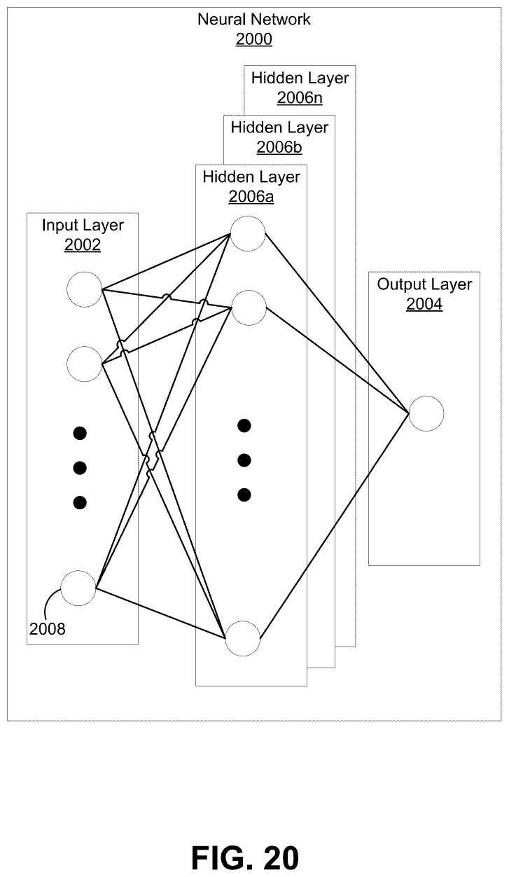

FIG. 20 is an illustrative example of a neural network 2000 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 2000 may be an example of, or can implement, object probability predictor 1704 of FIG. 17, object detector 1712 of FIG. 17, and/or image enhancer 1714 of FIG. 17.

An input layer 2002 includes input data. In one illustrative example, input layer 2002 can include data representing images 1604 of FIG. 16A and FIG. 17, and/or images 1614 of FIG. 16A and FIG. 17. Neural network 2000 includes multiple hidden layers, for example, hidden layers 2006a, 2006b, through 2006n. The hidden layers 2006a, 2006b, through hidden layer 2006n include “n” number of hidden layers, where “n” is an integer greater than or equal to one. The number of hidden layers can be made to include as many layers as needed for the given application. Neural network 2000 further includes an output layer 2004 that provides an output resulting from the processing performed by the hidden layers 2006a, 2006b, through 2006n. In one illustrative example, output layer 2004 can provide probabilities, determinations, and/or confidences regarding determinations.

Neural network 2000 may be, or may include, a multi-layer neural network of interconnected nodes. Each node can represent a piece of information. Information associated with the nodes is shared among the different layers and each layer retains information as information is processed. In some cases, neural network 2000 can include a feed-forward network, in which case there are no feedback connections where outputs of the network are fed back into itself. In some cases, neural network 2000 can include a recurrent neural network, which can have loops that allow information to be carried across nodes while reading in input.

Information can be exchanged between nodes through node-to-node interconnections between the various layers. Nodes of input layer 2002 can activate a set of nodes in the first hidden layer 2006a. For example, as shown, each of the input nodes of input layer 2002 is connected to each of the nodes of the first hidden layer 2006a. The nodes of first hidden layer 2006a can transform the information of each input node by applying activation functions to the input node information. The information derived from the transformation can then be passed to and can activate the nodes of the next hidden layer 2006b, which can perform their own designated functions. Example functions include convolutional, up-sampling, data transformation, and/or any other suitable functions. The output of the hidden layer 2006b can then activate nodes of the next hidden layer, and so on. The output of the last hidden layer 2006n can activate one or more nodes of the output layer 2004, at which an output is provided. In some cases, while nodes (e.g., node 2008) in neural network 2000 are shown as having multiple output lines, a node has a single output and all lines shown as being output from a node represent the same output value.

In some cases, each node or interconnection between nodes can have a weight that is a set of parameters derived from the training of neural network 2000. Once neural network 2000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 2000 to be adaptive to inputs and able to learn as more and more data is processed.

Neural network 2000 may be pre-trained to process the features from the data in the input layer 2002 using the different hidden layers 2006a, 2006b, through 2006n in order to provide the output through the output layer 2004. In an example in which neural network 2000 is used to identify features in images, neural network 2000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0.

In some cases, neural network 2000 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 2000 is trained well enough so that the weights of the layers are accurately tuned.

For the example of identifying objects in images, the forward pass can include passing a training image through neural network 2000. The weights are initially randomized before neural network 2000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 2000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 2000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target-output) 2. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 2000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and n denotes a learning rate. The learning rate can be set to any suitable value, with a high learning rate including larger weight updates and a lower value indicating smaller weight updates.

Neural network 2000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 2000 can include any other deep network other than a CNN, such as an autoencoder, a deep belief nets (DBNs), a Recurrent Neural Networks (RNNs), among others.

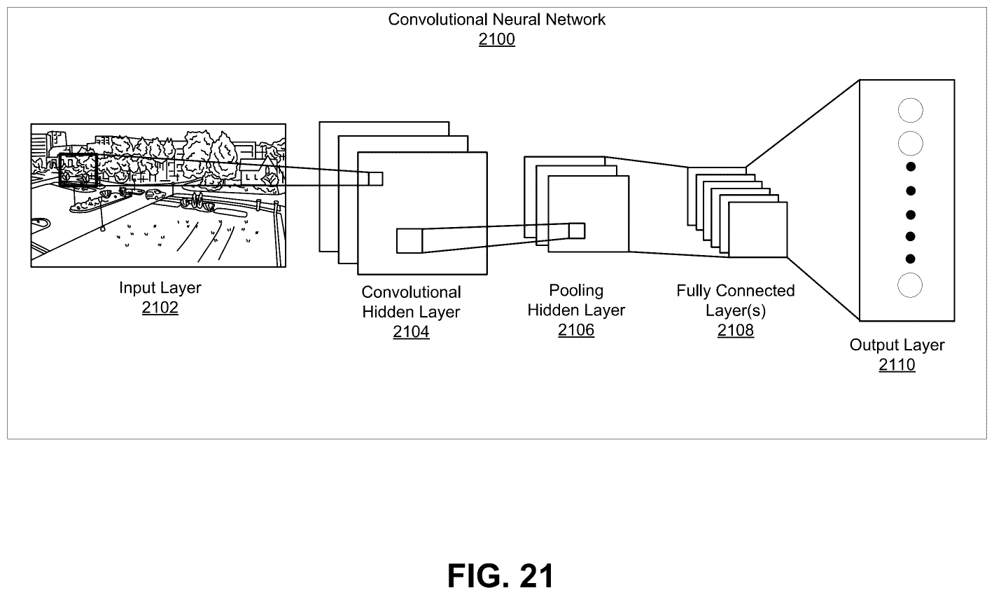

FIG. 21 is an illustrative example of a convolutional neural network (CNN) 2100. The input layer 2102 of the CNN 2100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2104, an optional non-linear activation layer, a pooling hidden layer 2106, and fully connected layer 2108 (which fully connected layer 2108 can be hidden) to get an output at the output layer 2110. While only one of each hidden layer is shown in FIG. 21, one of ordinary skill will appreciate that multiple convolutional hidden layers, non-linear layers, pooling hidden layers, and/or fully connected layers can be included in the CNN 2100. As previously described, the output can indicate a single class of an object or can include a probability of classes that best describe the object in the image.

The first layer of the CNN 2100 can be the convolutional hidden layer 2104. The convolutional hidden layer 2104 can analyze image data of the input layer 2102. Each node of the convolutional hidden layer 2104 is connected to a region of nodes (pixels) of the input image called a receptive field. The convolutional hidden layer 2104 can be considered as one or more filters (each filter corresponding to a different activation or feature map), with each convolutional iteration of a filter being a node or neuron of the convolutional hidden layer 2104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2104. Each connection between a node and a receptive field for that node learns a weight and, in some cases, an overall bias such that each node learns to analyze its particular local receptive field in the input image. Each node of the convolutional hidden layer 2104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 2104 is due to each node of the convolutional layer being applied to its corresponding receptive field. For example, a filter of the convolutional hidden layer 2104 can begin in the top-left corner of the input image array and can convolve around the input image. As noted above, each convolutional iteration of the filter can be considered a node or neuron of the convolutional hidden layer 2104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2104.

The mapping from the input layer to the convolutional hidden layer 2104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 2104 can include several activation maps in order to identify multiple features in an image. The example shown in FIG. 21 includes three activation maps. Using three activation maps, the convolutional hidden layer 2104 can detect three different kinds of features, with each feature being detectable across the entire image.

In some examples, a non-linear hidden layer can be applied after the convolutional hidden layer 2104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 2100 without affecting the receptive fields of the convolutional hidden layer 2104.

The pooling hidden layer 2106 can be applied after the convolutional hidden layer 2104 (and after the non-linear hidden layer when used). The pooling hidden layer 2106 is used to simplify the information in the output from the convolutional hidden layer 2104. For example, the pooling hidden layer 2106 can take each activation map output from the convolutional hidden layer 2104 and generates a condensed activation map (or feature map) using a pooling function. Max-pooling is one example of a function performed by a pooling hidden layer. Other forms of pooling functions be used by the pooling hidden layer 2106, such as average pooling, L2-norm pooling, or other suitable pooling functions. A pooling function (e.g., a max-pooling filter, an L2-norm filter, or other suitable pooling filter) is applied to each activation map included in the convolutional hidden layer 2104. In the example shown in FIG. 21, three pooling filters are used for the three activation maps in the convolutional hidden layer 2104.

In some examples, max-pooling can be used by applying a max-pooling filter (e.g., having a size of 2×2) with a stride (e.g., equal to a dimension of the filter, such as a stride of 2) to an activation map output from the convolutional hidden layer 2104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2104 having a dimension of 24×24 nodes, the output from the pooling hidden layer 2106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2100.

The final layer of connections in the network is a fully-connected layer that connects every node from the pooling hidden layer 2106 to every one of the output nodes in the output layer 2110. Using the example above, the input layer includes 28×28 nodes encoding the pixel intensities of the input image, the convolutional hidden layer 2104 includes 3×24×24 hidden feature nodes based on application of a 5×5 local receptive field (for the filters) to three activation maps, and the pooling hidden layer 2106 includes a layer of 3×12×12 hidden feature nodes based on application of max-pooling filter to 2×2 regions across each of the three feature maps. Extending this example, the output layer 2110 can include ten output nodes. In such an example, every node of the 3×12×12 pooling hidden layer 2106 is connected to every node of the output layer 2110.

The fully connected layer 2108 can obtain the output of the previous pooling hidden layer 2106 (which should represent the activation maps of high-level features) and determines the features that most correlate to a particular class. For example, the fully connected layer 2108 can determine the high-level features that most strongly correlate to a particular class and can include weights (nodes) for the high-level features. A product can be computed between the weights of the fully connected layer 2108 and the pooling hidden layer 2106 to obtain probabilities for the different classes. For example, if the CNN 2100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2110 can include an M-dimensional vector (in the prior example, M=10). M indicates the number of classes that the CNN 2100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 22 illustrates an example computing-device architecture 2200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2200 may include, implement, or be included in any or all of system 1600 of FIG. 16A, processor(s) 1606 of FIG. 16A and FIG. 17, and/or other devices, modules, or systems described herein. Additionally or alternatively, computing-device architecture 2200 may be configured to perform process 1800, process 1900, and/or other process described herein.

The components of computing-device architecture 2200 are shown in electrical communication with each other using connection 2212, such as a bus. The example computing-device architecture 2200 includes a processing unit (CPU or processor) 2202 and computing device connection 2212 that couples various computing device components including computing device memory 2210, such as read only memory (ROM) 2208 and random-access memory (RAM) 2206, to processor 2202.

Computing-device architecture 2200 can include a cache of high-speed memory connected directly with, in close proximity to, or integrated as part of processor 2202. Computing-device architecture 2200 can copy data from memory 2210 and/or the storage device 2214 to cache 2204 for quick access by processor 2202. In this way, the cache can provide a performance boost that avoids processor 2202 delays while waiting for data. These and other modules can control or be configured to control processor 2202 to perform various actions. Other computing device memory 2210 may be available for use as well. Memory 2210 can include multiple different types of memory with different performance characteristics. Processor 2202 can include any general-purpose processor and a hardware or software service, such as service 1 2216, service 2 2218, and service 3 2220 stored in storage device 2214, configured to control processor 2202 as well as a special-purpose processor where software instructions are incorporated into the processor design. Processor 2202 may be a self-contained system, containing multiple cores or processors, a bus, memory controller, cache, etc. A multi-core processor may be symmetric or asymmetric.

To enable user interaction with the computing-device architecture 2200, input device 2222 can represent any number of input mechanisms, such as a microphone for speech, a touch-sensitive screen for gesture or graphical input, keyboard, mouse, motion input, speech and so forth. Output device 2224 can also be one or more of a number of output mechanisms known to those of skill in the art, such as a display, projector, television, speaker device, etc. In some instances, multimodal computing devices can enable a user to provide multiple types of input to communicate with computing-device architecture 2200. Communication interface 2226 can generally govern and manage the user input and computing device output. There is no restriction on operating on any particular hardware arrangement and therefore the basic features here may easily be substituted for improved hardware or firmware arrangements as they are developed.

Storage device 2214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2206, read only memory (ROM) 2208, and hybrids thereof. Storage device 2214 can include services 2216, 2218, and 2220 for controlling processor 2202. Other hardware or software modules are contemplated. Storage device 2214 can be connected to the computing device connection 2212. In one aspect, a hardware module that performs a particular function can include the software component stored in a computer-readable medium in connection with the necessary hardware components, such as processor 2202, connection 2212, output device 2224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing one or more image frames, the apparatus comprising: at least one memory; and at least one processor coupled to the at least one memory and configured to: receive a first series of image frames from an image sensor; provide the first series of image frames to a display to be displayed; initiate an object-detection mode based on the first series of image frames; responsive to initiating the object-detection mode, initiate capture of a second series of image frames; determine exposures for the second series of image frames based on the second series of image frames; and store an image frame of the second series of image frames.
Aspect 2. The apparatus of aspect 1, wherein the image frame is stored based on a user input.
Aspect 3. The apparatus of aspect 2, wherein the user input is received while a first image frame of the first series of image frames is displayed by the display.
Aspect 4. The apparatus of any one of aspects 1 to 3, wherein the at least one processor is configured to provide the image frame to the display to be displayed.
Aspect 5. The apparatus of any one of aspects 1 to 4, wherein the at least one processor is configured to generate a composite image based on the image frame of the second series of image frames and an image frame of the first series of image frames.
Aspect 6. The apparatus of aspect 5, wherein the composite image comprises pixels representing an object detected by the object-detection mode from the image frame of the second series of image frames and pixels representing a remainder of a scene from the image frame of the first series of image frames.
Aspect 7. The apparatus of any one of aspects 5 or 6, wherein the composite image comprises pixels representing the image frame of the second series of image frames inset into the image frame of the first series of image frames.
Aspect 8. The apparatus of any one of aspects 5 to 7, wherein the at least one processor is configured to provide the composite image to the display to be displayed.
Aspect 9. The apparatus of aspect 8, wherein the composite image is displayed prior to a user input associated with capturing an image.
Aspect 10. The apparatus of any one of aspects 8 or 9, wherein the composite image is displayed responsive to a user input associated with capturing an image.
Aspect 11. The apparatus of any one of aspects 1 to 10, wherein the object-detection mode is initiated responsive to a confidence value indicative that a particular object is represented in the first series of images exceeding a confidence threshold.
Aspect 12. The apparatus of aspect 11, wherein the particular object is the moon.
Aspect 13. The apparatus of any one of aspects 1 to 12, wherein the object-detection mode is a moon-detection mode.
Aspect 14. The apparatus of any one of aspects 1 to 13, wherein the capture of the second series of image frames is initiated with an exposure value that is different from an exposure value of the first series of image frames.
Aspect 15. The apparatus of aspect 14, wherein the exposure value with which the second series of images frames is initiated is a predetermined amount lower than the exposure value of the first series of image frames.
Aspect 16. The apparatus of any one of aspects 1 to 15, wherein the second series of image frames is captured by the image sensor.
Aspect 17. The apparatus of any one of aspects 1 to 16, wherein the image sensor comprises a first image sensor and wherein the second series of image frames is captured by a second image sensor.
Aspect 18. The apparatus of any one of aspects 1 to 17, further comprising the image sensor.
Aspect 19. The apparatus of any one of aspects 1 to 18, further comprising the display.
Aspect 20. The apparatus of any one of aspects 1 to 19, wherein while the image frame is captured and stored, the first series of image frames is provided to the display to be displayed.
Aspect 21. The apparatus of any one of aspects 1 to 20, wherein the at least one processor is configured to enhance the image frame.
Aspect 22. A method for processing one or more image frames, the method comprising: receiving a first series of image frames from an image sensor; providing the first series of image frames to a display to be displayed; initiating an object-detection mode based on the first series of image frames; responsive to initiating the object-detection mode, initiating capture of a second series of image frames; determining exposures for the second series of image frames based on the second series of image frames; and storing an image frame of the second series of image frames.
Aspect 23. The method of aspect 22, wherein the image frame is stored based on a user input.
Aspect 24. The method of aspect 23, wherein the user input is received while a first image frame of the first series of image frames is displayed by the display.
Aspect 25. The method of any one of aspects 22 to 24, further comprising providing the image frame to the display to be displayed.
Aspect 26. The method of any one of aspects 22 to 25, further comprising generating a composite image based on the image frame of the second series of image frames and an image frame of the first series of image frames.
Aspect 27. The method of aspect 26, wherein the composite image comprises pixels representing an object detected by the object-detection mode from the image frame of the second series of image frames and pixels representing a remainder of a scene from the image frame of the first series of image frames.
Aspect 28. The method of any one of aspects 26 or 27, wherein the composite image comprises pixels representing the image frame of the second series of image frames inset into the image frame of the first series of image frames.
Aspect 29. The method of any one of aspects 26 to 28, further comprising providing the composite image to the display to be displayed.
Aspect 30. The method of aspect 29, wherein the composite image is displayed prior to a user input associated with capturing an image.
Aspect 31. The method of any one of aspects 29 or 30, wherein the composite image is displayed responsive to a user input associated with capturing an image.
Aspect 32. The method of any one of aspects 22 to 31, wherein the object-detection mode is initiated responsive to a confidence value indicative that a particular object is represented in the first series of images exceeding a confidence threshold.
Aspect 33. The method of aspect 32, wherein the particular object is the moon.
Aspect 34. The method of any one of aspects 22 to 33, wherein the object-detection mode is a moon-detection mode.
Aspect 35. The method of any one of aspects 22 to 34, wherein the capture of the second series of image frames is initiated with an exposure value that is different from an exposure value of the first series of image frames.
Aspect 36. The method of aspect 35, wherein the exposure value with which the second series of images frames is initiated is a predetermined amount lower than the exposure value of the first series of image frames.
Aspect 37. The method of any one of aspects 22 to 36, wherein the second series of image frames is captured by the image sensor.
Aspect 38. The method of any one of aspects 22 to 37, wherein the image sensor comprises a first image sensor and wherein the second series of image frames is captured by a second image sensor.
Aspect 39. The method of any one of aspects 22 to 38, wherein while the image frame is captured and stored, the first series of image frames is provided to the display to be displayed.
Aspect 40. The method of any one of aspects 22 to 39, further comprising enhancing the image frame.
Aspect 41. A non-transitory computer-readable storage medium having stored thereon instructions that, when executed by at least one processor, cause the at least one processor to perform operations according to any of aspects 22 to 40.
Aspect 42. An apparatus for providing virtual content for display, the apparatus comprising one or more means for perform operations according to any of aspects 22 to 40.

What is claimed is:

1. An apparatus for processing one or more image frames, the apparatus comprising:
at least one memory; and
at least one processor coupled to the at least one memory and configured to:
receive a first series of image frames from an image sensor;
provide the first series of image frames to a display to be displayed;
initiate an object-detection mode based on the first series of image frames;
responsive to initiating the object-detection mode, initiate capture of a second series of image frames;
determine exposures for the second series of image frames based on the second series of image frames; and
store an image frame of the second series of image frames.

2. The apparatus of claim 1, wherein the image frame is stored based on a user input.

3. The apparatus of claim 2, wherein the user input is received while a first image frame of the first series of image frames is displayed by the display.

4. The apparatus of claim 1, wherein the at least one processor is configured to provide the image frame to the display to be displayed.

5. The apparatus of claim 1, wherein the at least one processor is configured to generate a composite image based on the image frame of the second series of image frames and an image frame of the first series of image frames.

6. The apparatus of claim 5, wherein the composite image comprises pixels representing an object detected by the object-detection mode from the image frame of the second series of image frames and pixels representing a remainder of a scene from the image frame of the first series of image frames.

7. The apparatus of claim 5, wherein the composite image comprises pixels representing the image frame of the second series of image frames inset into the image frame of the first series of image frames.

8. The apparatus of claim 5, wherein the at least one processor is configured to provide the composite image to the display to be displayed.

9. The apparatus of claim 8, wherein the composite image is displayed prior to a user input associated with capturing an image.

10. The apparatus of claim 8, wherein the composite image is displayed responsive to a user input associated with capturing an image.

11. The apparatus of claim 1, wherein the object-detection mode is initiated responsive to a confidence value indicative that a particular object is represented in the first series of images exceeding a confidence threshold.

12. The apparatus of claim 11, wherein the particular object is the moon.

13. The apparatus of claim 1, wherein the object-detection mode is a moon-detection mode.

14. The apparatus of claim 1, wherein the capture of the second series of image frames is initiated with an exposure value that is different from an exposure value of the first series of image frames.

15. The apparatus of claim 14, wherein the exposure value with which the second series of images frames is initiated is a predetermined amount lower than the exposure value of the first series of image frames.

16. The apparatus of claim 1, wherein the second series of image frames is captured by the image sensor.

17. The apparatus of claim 1, wherein the image sensor comprises a first image sensor and wherein the second series of image frames is captured by a second image sensor.

18. The apparatus of claim 1, further comprising the image sensor.

19. The apparatus of claim 1, further comprising the display.

20. A method for processing one or more image frames, the method comprising:
receiving a first series of image frames from an image sensor;
providing the first series of image frames to a display to be displayed;
initiating an object-detection mode based on the first series of image frames;
responsive to initiating the object-detection mode, initiating capture of a second series of image frames;
determining exposures for the second series of image frames based on the second series of image frames; and
storing an image frame of the second series of image frames.
